(19) United States
(12) Patent Application Publication
(10) Pub. No.: US 2020/0203094 A1
(43) Pub. Date: Jun. 25, 2020

(54) SWITCH

(71) Applicant: Mitsubishi Electric Corporation, Tokyo (JP)

(72) Inventors: Katsuki HOTTA, Tokyo (JP); Takashi INAGUCHI, Tokyo (JP); Kazuki TAKAHASHI, Tokyo (JP)

(73) Assignee: Mitsubishi Electric Corporation, Tokyo (JP)

(21) Appl. No.: 16/614,803

(22) PCT Filed: Jun. 15, 2018
(86) PCT No.: PCT/JP2018/022884

§ 371 Date: Nov. 19, 2019

(30) Foreign Application Priority Data
Jul. 26, 2017 (JP) 2017-144406

(51) Int. Cl. H01H 9/44; H01H 1/54

(52) U.S. Cl. CPC H01H 9/443; H01H 2001/545; H01H 1/54

(57) ABSTRACT

A switch includes a first fixed contact, a second fixed contact, a movable contact, a drive shaft, a first outside yoke, a second outside yoke, a first inside yoke, a second inside yoke, and a permanent magnet. The permanent magnet magnetically couples the first outside yoke, the second outside yoke, the first inside yoke, and the second inside yoke, and produces a magnetic field component in a direction in which the first fixed contact point and the second fixed contact point are aligned, between the first fixed contact point and the first movable contact point and between the second fixed contact point and the second movable contact point.

### TECHNICAL FIELD

The present invention relates to a switch.

### BACKGROUND ART

Prior art documents disclosing a configuration of switches include Japanese Utility Model Laying-Open No. H1-109155 (PTL 1), WO2012/128080 (PTL 2), and Japanese Patent Laying-Open No. 2003-197053 (PTL 3).

The direct-current switch disclosed in PTL 1 includes a fixed contact having a fixed contact point, a movable contact having a movable contact point, a crossbar, a magnetic plate, and a permanent magnet. A magnetic field component in a direction vertical to the extending direction of the movable contact is produced between the fixed contact point and the movable contact point by the permanent magnet and the magnetic plate. An arc produced between the fixed contact point and the movable contact point is extended outward in the extending direction of the movable contact by this magnetic field component and extinguished.

The contact device disclosed in PTL 2 includes a fixed contact having fixed contact points, a movable contact having movable contact points, and a pair of permanent magnets sandwiching a pair of fixed contact points. When current flows through the movable contact in one direction, an arc produced between the contact points on one side is extended to one side of the direction vertical to the extending direction of the movable contact, and an arc produced between the contact points on the other side is extended to the opposite direction. When current flows through the movable contact in the other direction, the drive directions of the arcs are reversed.

The switch disclosed in PTL 3 includes a fixed contact having fixed contact points, a movable contact having movable contacts, an operating member coupled to the movable contact to open the contact points, magnetic field generating means for generating a magnetic field in the vicinity of the contact points, and magnetic lines of force guiding members. The magnetic field generating means generates a magnetic field in a direction along the extending direction of the movable contact between the fixed contact point and the movable contact point.

### CITATION LIST

### Patent Literature

PTL 1: Japanese Utility Model Laying-Open No. H1-109155

PTL 2: WO2012/128080

PTL 3: Japanese Patent Laying-Open No. 2003-197053

### SUMMARY OF INVENTION

### Technical Problem

In the switch disclosed in PTL 3, the magnetic lines of force guiding members are arranged symmetrically along the outer wall of the arc-extinguishing chamber case so as to extend along the magnetic line of force passing through the first contact point and the second contact point. There is therefore room to even more effectively exert a drive force on the arc.

The present invention is made in view of the problem above and an object of the present invention is to provide a switch with a high arc-extinguishing performance, in which a drive force is effectively exerted on an arc.

### Solution to Problem

A switch based on the present invention includes a first fixed contact, a second fixed contact, a movable contact, a drive shaft, a first outside yoke, a second outside yoke, a first inside yoke, a second inside yoke, and a permanent magnet. The first fixed contact has a first fixed contact point. The second fixed contact is disposed symmetrically to be aligned in a row with a gap from the first fixed contact. The second fixed contact has a second fixed contact point. The movable contact is disposed to a side of the first fixed contact point and the second fixed contact point. The movable contact has a first movable contact point at one end portion at a position facing the first fixed contact point and a second movable contact point at another end portion at a position facing the second fixed contact point. The drive shaft is formed of an insulator. The drive shaft is disposed to pass through the gap. The drive shaft moves the movable contact to the side. The first outside yoke is formed of a magnetic substance. A part of the first outside yoke is located at a position outside the one end portion of the movable contact in a direction in which the first fixed contact point and the second fixed contact point are aligned. The second outside yoke is formed of a magnetic substance. A part of the second outside yoke is located at a position outside the other end portion of the movable contact in the direction aligned. The first inside yoke is formed of a magnetic substance. A part of the first inside yoke is located at a position between the first fixed contact and the drive shaft. The second inside yoke is formed of a magnetic substance. A part of the second inside yoke is located at a position between the second fixed contact and the drive shaft. The permanent magnet is connected to each of the first outside yoke and the second outside yoke. The permanent magnet magnetically couples the first outside yoke, the second outside yoke, the first inside yoke, and the second inside yoke, and produces a magnetic field component in the direction aligned, between the first fixed contact point and the first movable contact point and between the second fixed contact point and the second movable contact point.

### Advantageous Effects of Invention

According to the present invention, a drive force can be effectively exerted on an arc, and the arc-extinguishing performance of the switch can be enhanced.

### BRIEF DESCRIPTION OF DRAWINGS

FIG. 1 is a front view of the appearance of a switch according to a first embodiment of the present invention.

FIG. 2 is a cross-sectional view of the switch in FIG. 1 as viewed from the direction of arrows II-II.

FIG. 3 is a partial enlarged view of the switch according to the first embodiment of the present invention with an arc cover removed as viewed from the front side.

FIG. 4 is a cross-sectional view as viewed from the direction of arrows IV-IV in FIG. 3.

FIG. 5 is a view of the appearance of a member forming the inside yoke of the switch according to the first embodiment of the present invention as viewed from the side.

FIG. 6 is a view of the member forming the inside yoke in FIG. 5 as viewed from the direction of arrow VI.

FIG. 7 is a partial enlarged view schematically showing the produced magnetic field distribution as viewed from the front side of the switch according to the first embodiment of the present invention with the arc cover removed.

FIG. 8 is a cross-sectional view as viewed from the direction of arrows VIII-VIII in FIG. 7.

FIG. 9 is a partial enlarged view schematically showing a drive force acting on an arc produced when forward current flows, as viewed from the front side of the switch according to the first embodiment of the present invention with the arc cover removed.

FIG. 10 is a partial enlarged view schematically showing a drive force acting on an arc produced when reverse current flows, as viewed from the front side of the switch according to the first embodiment of the present invention with the arc cover removed.

FIG. 11 is a diagram of the appearance of a member forming the inside yoke of the switch according to a second embodiment of the present invention as viewed from the side.

FIG. 12 is a view of the member forming the inside yoke in FIG. 11 as viewed from the direction of arrow XII.

FIG. 13 is a view of the member forming the inside yoke in FIG. 11 as viewed from the direction of arrow XIII.

FIG. 14 is a partial enlarged view of the switch according to a third embodiment of the present invention with the arc cover removed as viewed from the front side.

FIG. 15 is a cross-sectional view as viewed from the direction of arrows XV-XV in FIG. 14.

FIG. 16 is a view of the appearance of a member forming the inside yoke of the switch according to the third embodiment of the present invention as viewed from the side.

FIG. 17 is a view of the member forming the inside yoke in FIG. 16 as viewed from the direction of arrow XVII.

FIG. 18 is a partial enlarged view schematically showing the produced magnetic field distribution, as viewed from the front side of the switch according to the third embodiment of the present invention with the arc cover removed.

FIG. 19 is a cross-sectional view as viewed from the direction of arrows XIX-XIX in FIG. 18.

FIG. 20 is a partial enlarged view schematically showing a drive force acting on an arc produced when forward current flows, as viewed from the front side of the switch according to the third embodiment of the present invention with the arc cover removed.

FIG. 21 is a partial enlarged view schematically showing a drive force acting on an arc produced when reverse current flows, as viewed from the front side of the switch according to the third embodiment of the present invention with the arc cover removed.

FIG. 22 is a partial enlarged view of the switch according to a fourth embodiment of the present invention with the arc cover removed as viewed from the front side.

FIG. 23 is a cross-sectional view as viewed from the direction of arrows XXIII-XXIII in FIG. 22.

FIG. 24 is a view of the appearance of a member forming the inside yoke of the switch according to the fourth embodiment of the present invention as viewed from the side.

FIG. 25 is a view of the member forming the inside yoke in FIG. 24 as viewed from the direction of arrow XXV.

FIG. 26 is a partial enlarged view of the switch according to a fifth embodiment of the present invention with the arc cover removed as viewed from the front side.

FIG. 27 is a cross-sectional view as viewed from the direction of arrows XXVII-XXVII in FIG. 26.

FIG. 28 is a partial enlarged view of the switch according to a sixth embodiment of the present invention with the arc cover removed as viewed from the front side.

FIG. 29 is a cross-sectional view as viewed from the direction of arrows XXIX-XXIX in FIG. 28.

FIG. 30 is a partial enlarged view of the switch according to a seventh embodiment of the present invention with the arc cover removed as viewed from the front side.

FIG. 31 is a cross-sectional view as viewed from the direction of arrows XXXI-XXXI in FIG. 30.

FIG. 32 is a partial enlarged view of the switch according to an eighth embodiment of the present invention with the arc cover removed as viewed from the front side.

FIG. 33 is a cross-sectional view as viewed from the direction of arrows XXXIII-XXXIII in FIG. 32.

FIG. 34 is a partial enlarged view of the switch according to a ninth embodiment of the present invention with the arc cover removed as viewed from the front side.

FIG. 35 is a cross-sectional view as viewed from the direction of arrows XXXV-XXXV in FIG. 34.

FIG. 36 is a partial enlarged view of the switch according to a tenth embodiment of the present invention with the arc cover removed as viewed from the front side.

FIG. 37 is a cross-sectional view as viewed from the direction of arrows XXXVII-XXXVII in FIG. 36.

FIG. 38 is a cross-sectional view as viewed from the direction XXXVIII in FIG. 37.

### DESCRIPTION OF EMBODIMENTS

A switch according to embodiments of the present invention will be described below with reference to the drawings. In the following description of embodiments, the same or corresponding parts in the drawings are denoted by the same reference signs and a description thereof will not be repeated.

### First Embodiment

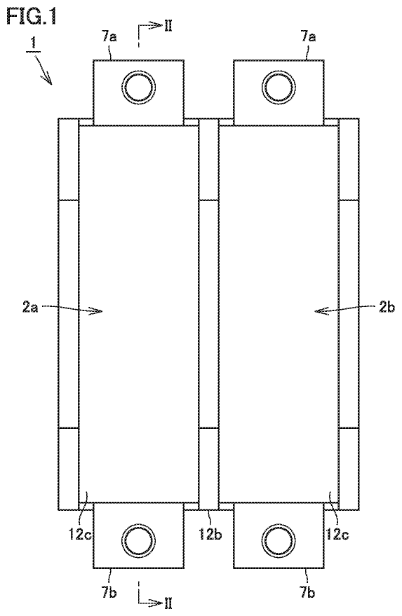

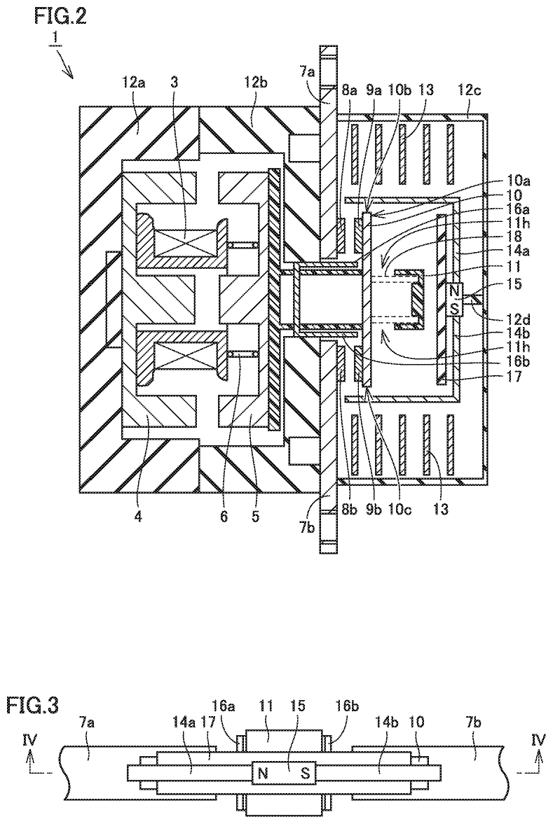

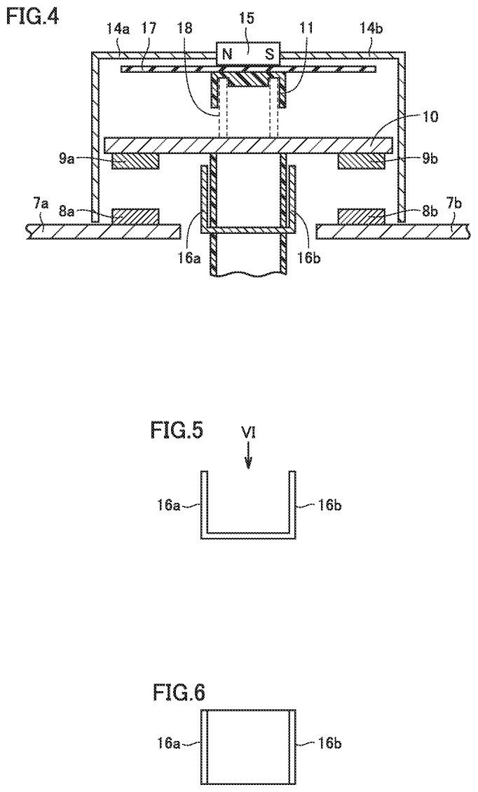

FIG. 1 is a front view of the appearance of a switch according to a first embodiment of the present invention. FIG. 2 is a cross-sectional view of the switch in FIG. 1 as viewed from the direction of arrows II-II. FIG. 3 is a partial enlarged view of the switch according to the first embodiment of the present invention with an arc cover removed as viewed from the front side. FIG. 4 is a cross-sectional view as viewed from the direction of arrows Iv-Iv in FIG. 3.

As shown in FIG. 1, switch 1 according to the first embodiment of the present invention includes a first-phase arc-extinguishing chamber 2a and a second-phase arc-extinguishing chamber 2b. First-phase arc-extinguishing chamber 2a and second-phase arc-extinguishing chamber 2b have configurations similar to each other. As shown in FIG. 1, switch 1 has a vertically symmetric shape and a horizontally symmetric shape. Switch 1 has at least one arc-extinguishing chamber.

As shown in FIG. 2 to FIG. 4, switch 1 according to the first embodiment of the present invention includes a first fixed contact 7a, a second fixed contact 7b, a movable contact 10, a drive shaft 11, a first outside yoke 14a, a second outside yoke 14b, a first inside yoke 16a, a second inside yoke 16b, and a permanent magnet 15. Switch 1 further includes a grid 13, an insulating plate 17, and an arc cover 12c.

First fixed contact 7a has a first fixed contact point 8a. First fixed contact 7a has an approximately rectangular parallelepiped outer shape. First fixed contact 7a has a longitudinal direction and has a through hole at one end portion in the longitudinal direction. First fixed contact point 8a is provided on one main surface of first fixed contact 7a. First fixed contact point 8a is located at the other end portion in the longitudinal direction of first fixed contact 7a.

Second fixed contact 7b is disposed symmetrically to be aligned in a row with a gap from first fixed contact 7a and has a second fixed contact point 8b. Second fixed contact 7b has an approximately rectangular parallelepiped outer shape. Second fixed contact 7b has a longitudinal direction and has a through hole at the other end portion in the longitudinal direction. Second fixed contact point 8b is provided on one main surface of second fixed contact 7b. Second fixed contact point 8b is located at one end portion in the longitudinal direction of second fixed contact 7b.

Movable contact 10 extends in an extending direction along the direction in which the first fixed contact point 8a and the second fixed contact point 8b are aligned. Movable contact 10 is disposed to the side of first fixed contact point 8a and second fixed contact point 8b. Movable contact 10 has an approximately rectangular parallelepiped outer shape. Movable contact 10 has a longitudinal direction which is the extending direction. Movable contact 10 has a first movable contact point 9a at one end portion in the extending direction and has a second movable contact point 9b at the other end portion in the extending direction. First movable contact point 9a and second movable contact point 9b are provided on the other main surface of movable contact 10.

First fixed contact point 8a and first movable contact point 9a face each other. First movable contact point 9a is provided to be able to come into contact with and separate from first fixed contact point 8a. Second fixed contact point 8b and second movable contact point 9b face each other. Second movable contact point 9b is provided to be able to come into contact with and separate from second fixed contact point 8b.

Drive shaft 11 is formed of an insulator. Drive shaft 11 is disposed to pass through a gap between first fixed contact 7a and second fixed contact 7b. Drive shaft 11 moves movable contact 10 in the axial direction vertical to the extending direction of movable contact 10 while keeping first fixed contact point 8a and first movable contact point 9a facing each other and while keeping second fixed contact point 8b and second movable contact point 9b facing each other. Drive shaft 11 thus moves movable contact 10 to the above-noted side.

Drive shaft 11 has a hollow portion on the front end side, and a contact pressure spring 18 is accommodated in the hollow portion. Drive shaft 11 has a pair of hole portions 11h into which movable contact 10 is inserted. Each of a pair of hole portions 11h extends along the axial direction of drive shaft 11. Drive shaft 11 is formed of resin or plastic having insulating properties. Contact pressure spring 18 is sandwiched between an inner surface on the front end side of drive shaft 11 and one main surface 10a of movable contact 10.

Permanent magnet 15 is provided at a position on the opposite side to first fixed contact 7a and second fixed contact 7b in the axial direction of drive shaft 11 with respect to movable contact 10. In the present embodiment, switch 1 includes only one permanent magnet 15 in each arc-extinguishing chamber. Insulating plate 17 is attached to a surface of permanent magnet 15 on the movable contact 10 side.

Insulating plate 17 has an approximately rectangular parallelepiped outer shape. Insulating plate 17 has a longitudinal direction in a direction along the extending direction of movable contact 10. The width of insulating plate 17 is larger than the width of permanent magnet 15 in a width direction vertical to each of the extending direction of movable contact 10 and the axial direction of drive shaft 11. As viewed from the axial direction of drive shaft 11, permanent magnet 15 as a whole overlaps insulating plate 17.

A support 12d is attached on a surface of permanent magnet 15 on the opposite side to the surface having insulating plate 17. Permanent magnet 15 is fixed to arc cover 12c by support 12d. In the present embodiment, permanent magnet 15 has a north pole on the first outside yoke 14a side and a south pole on the second outside yoke 14b side. The orientation of magnetic poles of permanent magnet 15 may be reversed.

First outside yoke 14a is formed of a magnetic substance such as iron, for example. One end of first outside yoke 14a is connected to permanent magnet 15. The other end of first outside yoke 14a is located in the vicinity of first fixed contact point 8a and first movable contact point 9a.

In the present embodiment, first outside yoke 14a has a portion extending in a direction along the extending direction of movable contact 10 and a portion extending in a direction along the axial direction of drive shaft 11. The portion extending in the direction along the extending direction of movable contact 10 in first outside yoke 14a faces one main surface 10a of movable contact 10 with a spacing therefrom. The portion extending in the direction along the axial direction of drive shaft 11 in first outside yoke 14a faces one end surface 10b of movable contact 10 with a spacing therefrom.

The shape of first outside yoke 14a is not limited to the shape described above as long as a part of first outside yoke 14a is located at a position outside one end portion of movable contact 10 in the direction along the extending direction of movable contact 10 as viewed from the axial direction of drive shaft 11, within a range in which a magnetic field component described later can be produced. That is, a part of first outside yoke 14a is located at a position outside one end portion of movable contact 10 in a direction in which first fixed contact point 8a and second fixed contact point 8b are aligned.

Second outside yoke 14b is formed of a magnetic substance such as iron, for example. One end of second outside yoke 14b is connected to permanent magnet 15. The other end of second outside yoke 14b is located in the vicinity of second fixed contact point 8b and second movable contact point 9b.

In the present embodiment, second outside yoke 14b has a portion extending in a direction along the extending direction of movable contact 10 and a portion extending in a direction along the axial direction of drive shaft 11. The portion extending in a direction along the extending direction of movable contact 10 in second outside yoke 14b faces one main surface 10a of movable contact 10 with a spacing therefrom. The portion extending in a direction along the axial direction of drive shaft 11 in second outside yoke 14b faces the other end surface 10c of movable contact 10 with a spacing therefrom.

The shape of second outside yoke 14b is not limited to the shape described above as long as a part of second outside yoke 14b is located at a position outside the other end portion of movable contact 10 in a direction along the extending direction of movable contact 10 as viewed from the axial direction of drive shaft 11, within a range in which a magnetic field component described later can be produced. That is, a part of second outside yoke 14b is located at a position outside the other end portion of movable contact 10 in a direction in which first fixed contact point 8a and second fixed contact point 8b are aligned.

FIG. 5 is a view of the appearance of a member forming the inside yoke of the switch according to the first embodiment of the present invention as viewed from the side. FIG. 6 is a view of the member forming the inside yoke in FIG. 5 as viewed from the direction of arrow VI.

As shown in FIG. 5 and FIG. 6, in the present embodiment, first inside yoke 16a and second inside yoke 16b are integrally formed. The member forming the inside yoke is formed of a magnetic substance such as iron, for example. The member forming the inside yoke is formed by bending a plate-shaped magnetic substance.

First inside yoke 16a and second inside yoke 16b face each other with a spacing therebetween. Each of first inside yoke 16a and second inside yoke 16b has a flat plate-like shape. Each of first inside yoke 16a and second inside yoke 16b has a rectangular shape as viewed from the direction in which they face each other.

One end portion of first inside yoke 16a and one end portion of second inside yoke 16b are connected to each other by a connection portion extending in a direction vertical to each of first inside yoke 16a and second inside yoke 16b. This connection portion is attached to drive shaft 11 so as to extend in a direction vertical to the axial direction of drive shaft 11. As a result, each of first inside yoke 16a and second inside yoke 16b is connected to drive shaft 11. In the present embodiment, the member forming the inside yoke and drive shaft 11 are integrally formed.

First inside yoke 16a is located at a position between first fixed contact 7a and drive shaft 11, as viewed from the axial direction of drive shaft 11. Second inside yoke 16b is located at a position between second fixed contact 7b and drive shaft 11, as viewed from the axial direction of drive shaft 11.

In the present embodiment, a part of first outside yoke 14a and a part of first inside yoke 16a face each other between first fixed contact point 8a and first movable contact point 9a, as viewed from a direction along the extending direction of movable contact 10. In the above-noted width direction, the outer width of first inside yoke 16a is larger than the outer width of first outside yoke 14a.

First outside yoke 14a and first inside yoke 16a do not necessarily face each other. However, it is preferable that a part of first outside yoke 14a and a part of first inside yoke 16a are located between first fixed contact point 8a and first movable contact point 9a as viewed from a direction along the extending direction of movable contact 10, in terms of producing a magnetic field component described later. The outer width of first inside yoke 16a may be equivalent to the outer width of first outside yoke 14a.

In the present embodiment, a part of second outside yoke 14b and a part of second inside yoke 16b face each other between second fixed contact point 8b and second movable contact point 9b, as viewed from a direction along the extending direction of movable contact 10. In the above-noted width direction, the outer width of second inside yoke 16b is larger than the outer width of second outside yoke 14b.

Second outside yoke 14b and second inside yoke 16b do not necessarily face each other. However, it is preferable that a part of second outside yoke 14b and a part of second inside yoke 16b are located between second fixed contact point 8b and second movable contact point 9b as viewed from a direction along the extending direction of movable contact 10, in terms of producing a magnetic field component described later. The outer width of second inside yoke 16b may be equivalent to the outer width of second outside yoke 14b.

Arc cover 12c is formed of an insulator. Grid 13 is provided on an inner surface of arc cover 12c. Grid 13 is formed of a non-magnetic metal such as stainless steel or copper or a non-magnetic ceramic. Grid 13 is electrically insulated from first fixed contact 7a, second fixed contact 7b, first fixed contact point 8a, second fixed contact point 8b, first movable contact point 9a, second movable contact point 9b, and movable contact 10. In the present embodiment, grid 13 is provided in order to further enhance the arc interruption performance. However, grid 13 is not necessarily provided.

As shown in FIG. 2, a region surrounded by first fixed contact 7a, second fixed contact 7b, and arc cover 12c serves as an arc-extinguishing chamber.

As shown in FIG. 2, switch 1 according to the first embodiment of the present invention further includes an operating coil 3, a fixed core 4, a movable core 5, a tripping spring 6, a mount 12a, and a base 12b.

Mount 12a and base 12b are connected to each other to form a box. The box accommodates operating coil 3, movable core 5, fixed core 4, and tripping spring 6. Operating coil 3 is disposed on the outer peripheral side of the leg at movable core 5 and fixed core 4. Fixed core 4 is fixed to mount 12a. Tripping spring 6 is sandwiched between operating coil 3 and movable core 5. Movable core 5 is connected to drive shaft 11.

Base 12b has an opening into which drive shaft 11 is inserted. First fixed contact 7a and second fixed contact 7b are attached to base 12b on the opposite side to mount 12a.

Each of mount 12a and base 12b is formed of an insulator. Since first fixed contact 7a and second fixed contact 7b are attached to base 12b, a material excellent in heat resistance and insulating properties, such as synthetic resin or a material including a glass material in synthetic resin, is used for base 12b.

Each of movable core 5 and fixed core 4 is formed of a magnetic substance such as iron, for example. Each of movable core 5 and fixed core 4 may be formed with a stack of magnetic steel sheets.

The operation of switch 1 according to the first embodiment of the present invention will be described below.

When switch 1 is closed, first, operating coil 3 is energized. With operating coil 3 being energized, movable core 5 is pulled to fixed core 4 against the biasing force of tripping spring 6. Then, drive shaft 11 fixed to movable core 5 is also moved toward fixed core 4. With the movement of drive shaft 11, movable contact 10 also moves, first movable contact point 9a comes into contact with first fixed contact point 8a, and second movable contact point 9b comes into contact with second fixed contact point 8b.

Even after first movable contact point 9a comes into contact with first fixed contact point 8a and second movable contact point 9b comes into contact with second fixed contact point 8b, drive shaft 11 keeps moving toward fixed core 4. At this moment, movable contact 10 moves near the front end of drive shaft 11 in a pair of hole portions 11h of drive shaft 11 while flexing contact pressure spring 18.

The biasing force of contact pressure spring 18 presses first movable contact point 9a against first fixed contact point 8a and presses second movable contact point 9b against second fixed contact point 8b. Thus, the contact resistance between first movable contact point 9a and first fixed contact point 8a can be sufficiently reduced. The contact resistance between second movable contact point 9b and second fixed contact point 8b also can be sufficiently reduced.

Through the operation above, first fixed contact 7a, first fixed contact point 8a, first movable contact point 9a, movable contact 10, second movable contact point 9b, second fixed contact point 8b, and second fixed contact 7b are electrically connected to bring switch 1 into the closed state. With switch 1 in the closed state, forward current or reverse current described later is fed through switch 1.

When switch 1 is opened, the energization of operating coil 3 is stopped. Movable core 5 is pulled apart from fixed core 4 by the biasing force of tripping spring 6. Thus, drive shaft 11 fixed to movable core 5 also moves in a direction away from fixed core 4. At this moment, contact pressure spring 18 extends with the movement of drive shaft 11, and the biasing force of contact pressure spring 18 decreases.

When movable contact 10 comes into contact with the base ends of a pair of hole portions 11h of drive shaft 11 and starts moving together with drive shaft 11, first movable contact point 9a is detached from first fixed contact point 8a, and second movable contact point 9b is detached from second fixed contact point 8b.

Through the operation above, switch 1 becomes opened. At the moment when first movable contact point 9a is detached from first fixed contact point 8a, a high-temperature arc occurs between first movable contact point 9a and first fixed contact point 8a. Similarly, at the moment when second movable contact point 9b is detached from second fixed contact point 8b, a high-temperature occurs between second movable contact point 9b and second fixed contact point 8b. Since an arc has conductivity, current flows through the original current path until the arc is extinguished even after opening of the switch.

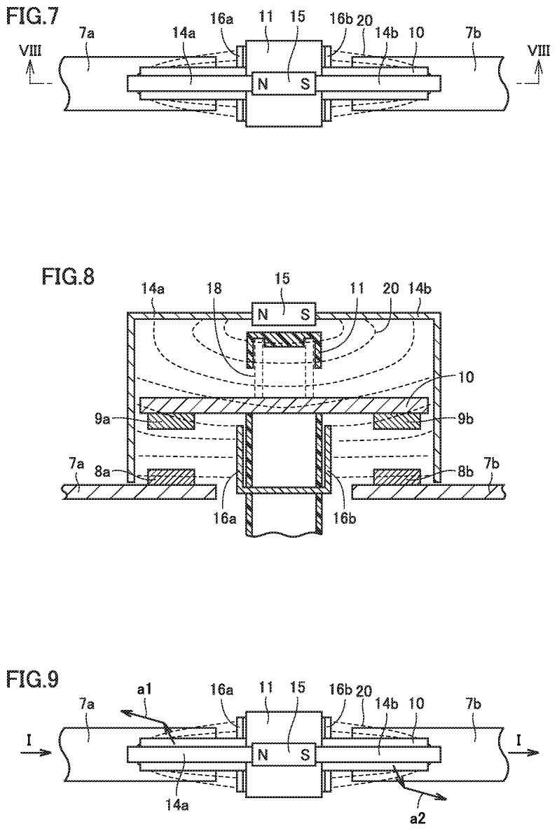

A magnetic field produced by permanent magnet 15 in switch 1 according to the first embodiment of the present invention will now be described. FIG. 7 is a partial enlarged view schematically showing the produced magnetic field distribution, as viewed from the front side of the switch according to the first embodiment of the present invention with the arc cover removed. FIG. 8 is a cross-sectional view as viewed from the direction of arrows VIII-VIII in FIG. 7. In FIG. 7 and FIG. 8, insulating plate 17 is not shown.

As shown in FIG. 7 and FIG. 8, magnetic flux 20 is distributed in a closed loop shape emitted from the north pole of permanent magnet 15 toward the south pole of permanent magnet 15. Magnetic flux 20 intensively passes through first outside yoke 14a, first inside yoke 16a, second inside yoke 16b, and second outside yoke 14b which are formed of a magnetic substance having the property of allowing magnetic flux to easily pass through in the air. That is, permanent magnet 15 magnetically couples first outside yoke 14a, second outside yoke 14b, first inside yoke 16a, and second inside yoke 16b.

As a result, permanent magnet 15 produces a magnetic field component in a direction along the extending direction of movable contact 10 between first fixed contact point 8a and first movable contact point 9a and between second fixed contact point 8b and second movable contact point 9b. That is, permanent magnet 15 produces a magnetic field component in a direction in which first fixed contact point 8a and second fixed contact point 8b are aligned, between first fixed contact point 8a and first movable contact point 9a and between second fixed contact point 8b and second movable contact point 9b.

In the present embodiment, as shown in FIG. 7, since the outer width of first inside yoke 16a is larger than outer width of first outside yoke 14a, magnetic flux 20 is distributed so as to expand in the above-noted width direction in the vicinity of first inside yoke 16a and to converge in the vicinity of first outside yoke 14a. Similarly, since the outer width of second inside yoke 16b is larger than the outer width of second outside yoke 14b, magnetic flux 20 is distributed so as to expand in the above-noted width direction in the vicinity of second inside yoke 16b and to converge in the vicinity of second outside yoke 14b.

FIG. 9 is a partial enlarged view schematically showing a drive force acting on an arc produced when forward current flows, as viewed from the front side of the switch according to the first embodiment of the present invention with the arc cover removed. In FIG. 9, insulating plate 17 is not shown.

As shown in FIG. 9, current I flowing through first fixed contact 7a, first fixed contact point 8a, first movable contact point 9a, movable contact 10, second movable contact point 9b, second fixed contact point 8b, and second fixed contact 7b in this order is regarded as forward current.

When forward current flows, according to Fleming's rule, drive force a1 acts on the arc produced between first fixed contact point 8a and first movable contact point 9a, and drive force a2 acts on the arc produced between second fixed contact point 8b and second movable contact point 9b.

In the region sandwiched between first outside yoke 14a and first inside yoke 16a in the extending direction of movable contact 10, there is a tendency that magnetic flux 20 develops in a direction along the extending direction of movable contact 10 and the development direction of magnetic flux 20 is inclined to the above-noted width direction as the distance from this region increases in the above-noted width direction. This tendency significantly appears since the outer width of first inside yoke 16a is larger than the outer width of first outside yoke 14a in the present embodiment.

For the arc produced between first fixed contact point 8a and first movable contact point 9a, drive force a1 therefore mainly acts on one side in the above-noted width direction and thereafter mainly acts in a direction away from movable contact 10 in the extending direction of movable contact 10. As a result, the arc produced between first fixed contact point 8a and first movable contact point 9a is extended long under the action of drive force a1.

Similarly, for the arc produced between second fixed contact point 8b and second movable contact point 9b, drive force a2 mainly acts on the other side in the above-noted width direction and thereafter mainly acts in a direction away from movable contact 10 in the extending direction of movable contact 10. As a result, the arc produced between second fixed contact point 8b and second movable contact point 9b is extended long under the action of drive force a2.

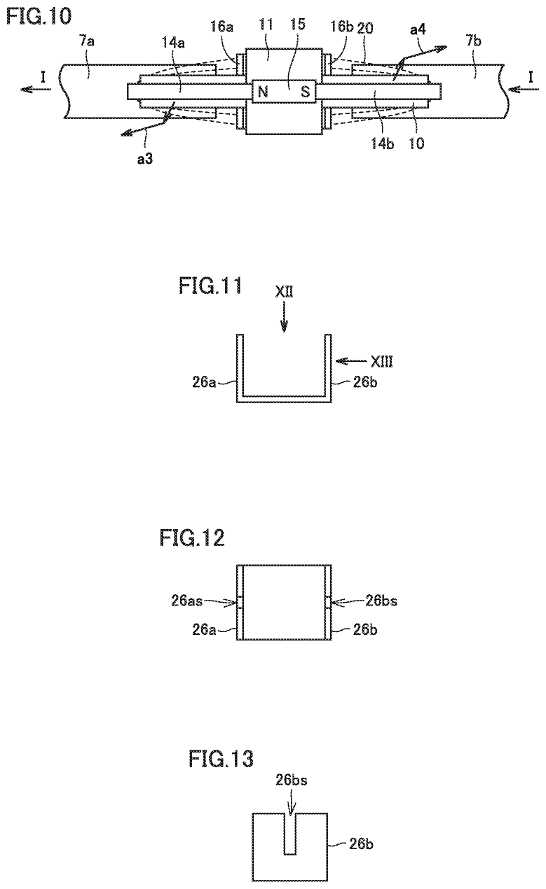

FIG. 10 is a partial enlarged view schematically showing a drive force acting on an arc produced when reverse current flows, as viewed from the front side of the switch according to the first embodiment of the present invention with the arc cover removed. In FIG. 10, insulating plate 17 is not shown.

As shown in FIG. 10, current I flowing through second fixed contact 7b, second fixed contact point 8b, second movable contact point 9b, movable contact 10, first movable contact point 9a, first fixed contact point 8a, and first fixed contact 7a in this order is regarded as reverse current.

When reverse current flows, according to Fleming's rule, drive force a3 acts on the arc produced between first fixed contact point 8a and first movable contact point 9a, and drive force a4 acts on the arc produced between second fixed contact point 8b and second movable contact point 9b.

For the arc produced between first fixed contact point 8a and first movable contact point 9a, drive force a3 mainly acts on the other side in the above-noted width direction and thereafter mainly acts in a direction away from movable contact 10 in the extending direction of movable contact 10. As a result, the arc produced between first fixed contact point 8a and first movable contact point 9a is extended long under the action of drive force a3.

Similarly, for the arc produced between second fixed contact point 8b and second movable contact point 9b, drive force a4 mainly acts on one side in the above-noted width direction and thereafter mainly acts in a direction away from movable contact 10 in the extending direction of movable contact 10. As a result, the arc produced between second fixed contact point 8b and second movable contact point 9b is extended long under the action of drive force a4.

As described above, in switch 1 according to the first embodiment of the present invention, both when forward current flows and when reverse current flows, the drive force can be exerted on the arc on either side in the above-noted width direction and thereafter exerted in a direction away from movable contact 10 in the extending direction of movable contact 10.

The arc extended under the action of drive force is extended up to a sufficiently long arc length or cooled in contact with grid 13 and extinguished. Current I is thus interrupted.

In switch 1 according to the first embodiment of the present invention, permanent magnet 15 magnetically couples first outside yoke 14a, second outside yoke 14b, first inside yoke 16a, and second inside yoke 16b, and produces a magnetic field component in a direction along the extending direction of movable contact 10 between first fixed contact point 8a and first movable contact point 9a and between second fixed contact point 8b and second movable contact point 9b. As a result, the drive force can be effectively exerted on the arc, and the arc-extinguishing performance of switch 1 can be enhanced.

In particular, in the above-noted width direction, the outer width of first inside yoke 16a is larger than the outer width of first outside yoke 14a, and the outer width of second inside yoke 16b is larger than the outer width of second outside yoke 14b, whereby the drive force can be exerted on either side in the above-noted width direction and thereafter effectively exerted in a direction away from movable contact 10 in the extending direction of movable contact 10, and therefore the arc can be extended longer. Thus, the arc-extinguishing performance of switch 1 can be further enhanced.

The effect above can be achieved both when forward current and when reverse current flows.

In order to ensure equivalent interruption performance in both current directions, it is preferable that the magnetic field distribution is plane-symmetric with respect to a plane passing through the center of movable contact 10 in the extending direction of movable contact 10 and parallel to the above-noted width direction.

In the present embodiment, only one permanent magnet 15 is disposed in one arc-extinguishing chamber. The required number of permanent magnets 15 is reduced whereby the manufacturing cost of switch 1 can be reduced. First inside yoke 16a and second inside yoke 16b are integrally formed whereby the number of components is reduced and the manufacturing cost of switch 1 can be reduced as well.

Since permanent magnet 15 is disposed at a position at a distance from between first fixed contact point 8a and first movable contact point 9a and from between second fixed contact point 8b and second movable contact point 9b, where an arc is generated, thermal demagnetization of permanent magnet 15 by heat of the arc can be suppressed.

Since the entire permanent magnet 15 overlaps insulating plate 17 as viewed from the axial direction of drive shaft 11, the effect of heat of arc on permanent magnet 15 also can be suppressed. The arc-extinguishing performance of switch 1 thus can be kept for a long time.

In the present embodiment, since each of first inside yoke 16a and second inside yoke 16b is connected to drive shaft 11, a notch for preventing interference with movable contact 10 need not be provided in each of first inside yoke 16a and second inside yoke 16b.

### Second Embodiment

The switch according to a second embodiment of the present invention will be described below.

The switch according to the second embodiment of the present invention differs from switch 1 in the first embodiment only in the shape of each of the first inside yoke and the second inside yoke, and a description of the configuration similar to that of switch 1 in the first embodiment is not repeated.

FIG. 11 is a view of the appearance of a member forming the inside yoke of the switch according to the second embodiment of the present invention as viewed from the side. FIG. 12 is a view of the member forming the inside yoke in FIG. 11 as viewed from the direction of arrow XII. FIG. 13 is a view of the member forming the inside yoke in FIG. 11 as viewed from the direction of arrow XIII.

As shown in FIG. 11 to FIG. 13, in the switch according to the second embodiment of the present invention, a first inside yoke 26a has a notch portion 26as extending in the above-noted axial direction at a center portion in the above-noted width direction. A second inside yoke 26b has a notch portion 26bs extending in the above-noted axial direction at a center portion in the above-noted width direction. Notch portion 26as and notch portion 26bs have approximately the same shape and are open on the movable contact 10 side.

Since notch portion 26as is provided in first inside yoke 26a, converging of the magnetic flux produced between first outside yoke 14a and first inside yoke 26a near the center portion of first inside yoke 26a in the above-noted width direction can be reduced, and the magnetic flux distribution can be expanded in the above-noted width direction.

Similarly, since notch portion 26bs is provided in second inside yoke 26b, converging of the magnetic flux produced between second outside yoke 14b and second inside yoke 26b near the center portion of second inside yoke 26b in the above-noted width direction can be reduced, and the magnetic flux distribution can be expanded in the above-noted width direction.

Thus, the drive force can be exerted more effectively on the arc in a direction away from movable contact 10 in the extending direction of movable contact 10. As a result, the drive force can be effectively exerted on the arc, and the arc-extinguishing performance of the switch can be enhanced.

When the width of each of notch portion 26as and notch portion 26bs is larger than the width of movable contact 10, first inside yoke 26a and second inside yoke 26b may be connected to the peripheral surface of the opening of base 12b, rather than being connected to drive shaft 11. In this case, an opening through which drive shaft 11 passes is provided at the connection portion connecting first inside yoke 26a and second inside yoke 26b.

Also in the present embodiment, permanent magnet 15 magnetically couples first outside yoke 14a, second outside yoke 14b, first inside yoke 26a, and second inside yoke 26b, and produces a magnetic field component in a direction along the extending direction of movable contact 10 between first fixed contact point 8a and first movable contact point 9a and between second fixed contact point 8b and second movable contact point 9b. As a result, the drive force can be effectively exerted on the arc, and the arc-extinguishing performance of the switch can be enhanced.

### Third Embodiment

The switch according to a third embodiment of the present invention will be described below.

The switch according to the third embodiment of the present invention differs from switch 1 in the first embodiment mainly in the configuration of the permanent magnet, the first outside yoke, the second outside yoke, the first inside yoke, and the second inside yoke, and a description of the configuration similar to that of switch 1 in the first embodiment is not repeated.

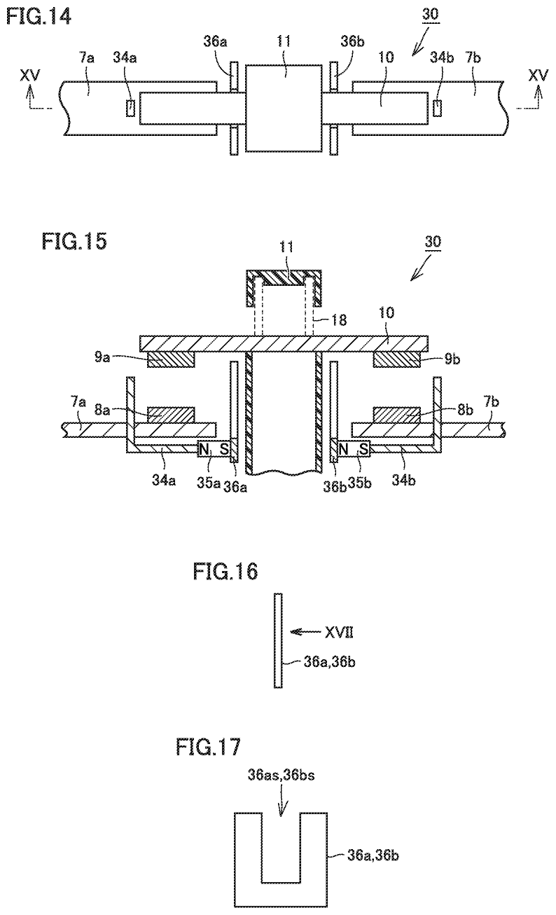

FIG. 14 is a partial enlarged view of the switch according to the third embodiment of the present invention with the arc cover removed as viewed from the front side. FIG. 15 is a cross-sectional view as viewed from the direction of arrows XV-XV in FIG. 14.

As shown in FIG. 14 and FIG. 15, switch 30 according to the third embodiment of the present invention includes a first fixed contact 7a, a second fixed contact 7b, a movable contact 10, a drive shaft 11, a first outside yoke 34a, a second outside yoke 34b, a first inside yoke 36a, a second inside yoke 36b, a first permanent magnet 35a, and a second permanent magnet 35b.

First permanent magnet 35a and second permanent magnet 35b are provided at a position on the opposite side to movable contact 10 in the axial direction of drive shaft 11 with respect to first fixed contact 7a and second fixed contact 7b. In the present embodiment, switch 30 includes two permanent magnets in each arc-extinguishing chamber.

First outside yoke 34a is formed of a magnetic substance such as iron, for example. First outside yoke 34a has an insulation coating. One end of first outside yoke 34a is connected to the north pole of first permanent magnet 35a. The other end of first outside yoke 34a is located in the vicinity of first fixed contact point 8a and first movable contact point 9a.

In the present embodiment, first outside yoke 34a has a portion extending in a direction along the extending direction of movable contact 10 and a portion extending in a direction along the axial direction of drive shaft 11. The portion extending in a direction along the extending direction of movable contact 10 in first outside yoke 34a faces the other main surface of movable contact 10 with a spacing therefrom. The portion extending in a direction along the axial direction of drive shaft 11 in first outside yoke 34a passes through a center portion of first fixed contact 7a in the above-noted width direction.

The shape of first outside yoke 34a is not limited to the shape described above as long as a part of first outside yoke 34a is located at a position outside one end portion of movable contact 10 in a direction along the extending direction of movable contact 10 as viewed from the axial direction of drive shaft 11, within a range in which a magnetic field component described later can be produced.

Second outside yoke 34b is formed of a magnetic substance such as iron, for example. Second outside yoke 34b has an insulation coating. One end of second outside yoke 34b is connected to the south pole of second permanent magnet 35b. The other end of second outside yoke 34b is located in the vicinity of second fixed contact point 8b and second movable contact point 9b.

In the present embodiment, second outside yoke 34b has a portion extending in a direction along the extending direction of movable contact 10 and a portion extending in a direction along the axial direction of drive shaft 11. The portion extending in a direction along the extending direction of movable contact 10 in second outside yoke 34b faces the other main surface of movable contact 10 with a spacing therefrom. The portion extending in a direction along the axial direction of drive shaft 11 in second outside yoke 34b passes through a center portion of second fixed contact 7b in the above-noted width direction.

The shape of second outside yoke 34b is not limited to the shape described above as long as a part of second outside yoke 34b is located at a position outside the other end portion of movable contact 10 in a direction along the extending direction of movable contact 10 as viewed from the axial direction of drive shaft 11, within a range in which a magnetic field component described later can be produced.

FIG. 16 is a view of the appearance of a member forming the inside yoke of the switch according to the third embodiment of the present invention as viewed from the side. FIG. 17 is a view of the member forming the inside yoke in FIG. 16 as viewed from the direction of arrow XVII.

As shown in FIG. 16 and FIG. 17, in the present embodiment, first inside yoke 36a and second inside yoke 36b are configured as separate parts. Each of first inside yoke 36a and second inside yoke 36b is formed of a sheet of magnetic substance such as iron. Each of first inside yoke 36a and second inside yoke 36b has a rectangular outer shape. Each of first inside yoke 36a and second inside yoke 36b has an insulation coating.

First inside yoke 36a has a notch portion 36as extending in the above-noted axial direction at a center portion in the above-noted width direction. Second inside yoke 36b has a notch portion 36bs extending in the above-noted axial direction at a center portion in the above-noted width direction. Notch portion 36as and notch portion 36bs have approximately the same shape and are open on the movable contact 10 side. The width of each of notch portion 36as and notch portion 36bs is larger than the width of movable contact 10. This can prevent each of first inside yoke 36a and second inside yoke 36b from interfering with movable contact 10.

One end portion of first inside yoke 36a is connected to the south pole of first permanent magnet 35a. One end portion of second inside yoke 36b is connected to the north pole of second permanent magnet 35b. The orientation of magnetic poles of each of first permanent magnet 35a and second permanent magnet 35b may be reversed. For example, one end portion of first inside yoke 36a may be connected to the north pole of first permanent magnet 35a, and one end portion of second inside yoke 36b may be connected to the south pole of second permanent magnet 35b. If the orientation of magnetic poles is changed, the arc driving direction described later is changed but the arc driving ability and the resulting interruption performance are equivalent.

First inside yoke 36a is located at a position between first fixed contact 7a and drive shaft 11 as viewed from the axial direction of drive shaft 11. Second inside yoke 36b is located at a position between second fixed contact 7b and drive shaft 11 as viewed from the axial direction of drive shaft 11.

In the present embodiment, a part of first outside yoke 34a and a part of first inside yoke 36a face each other between first fixed contact point 8a and first movable contact point 9a, as viewed from a direction along the extending direction of movable contact 10. The outer width of first inside yoke 36a is larger than the outer width of first outside yoke 34a in the above-noted width direction.

Although first outside yoke 34a and first inside yoke 36a do not necessarily face each other, it is preferable that a part of first outside yoke 34a and a part of first inside yoke 36a are located between first fixed contact point 8a and first movable contact point 9a as viewed from a direction along the extending direction of movable contact 10, in terms of producing a magnetic field component described later. The outer width of first inside yoke 36a may be equivalent to the outer width of first outside yoke 34a.

In the present embodiment, a part of second outside yoke 34b and a part of second inside yoke 36b face each other between second fixed contact point 8b and second movable contact point 9b, as viewed from a direction along the extending direction of movable contact 10. The outer width of second inside yoke 36b is larger than the outer width of second outside yoke 34b in the above-noted width direction.

Although second outside yoke 34b and second inside yoke 36b do not necessarily face each other, it is preferable that a part of second outside yoke 34b and a part of second inside yoke 36b are located between second fixed contact point 8b and second movable contact point 9b as viewed from a direction along the extending direction of movable contact 10, in terms of producing a magnetic field component described later. The outer width of second inside yoke 36b may be equivalent to the outer width of second outside yoke 34b.

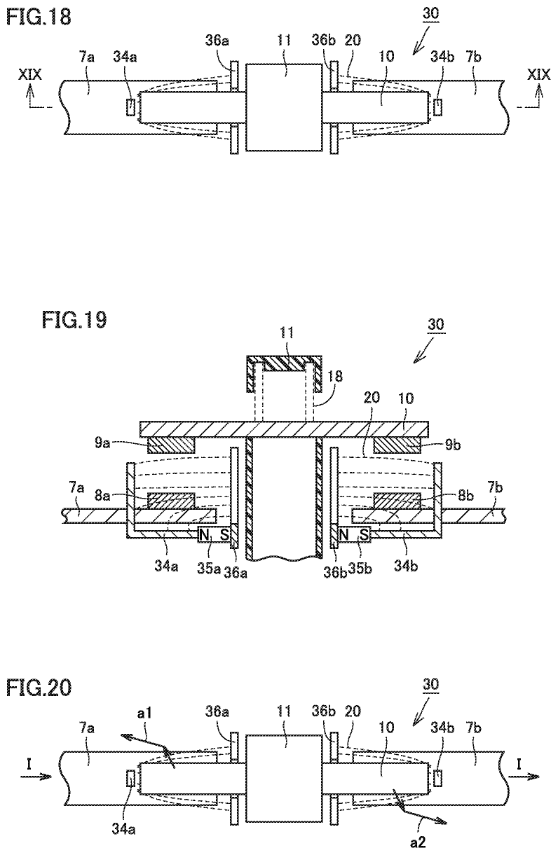

A magnetic field produced by first permanent magnet 35a and second permanent magnet 35b in switch 30 according to the third embodiment of the present invention will now be described. FIG. 18 is a partial enlarged view schematically showing the produced magnetic field distribution as viewed from the front side of the switch according to the third embodiment of the present invention with the arc cover removed. FIG. 19 is a cross-sectional view as viewed from the direction of arrows XIX-XIX in FIG. 18.

As shown in FIG. 18 and FIG. 19, magnetic flux 20 is distributed in a closed loop shape emitted from the north pole of first permanent magnet 35a toward the south pole of second permanent magnet 35b. Magnetic flux 20 intensively passes through first outside yoke 34a, first inside yoke 36a, second inside yoke 36b, and second outside yoke 34b which are formed of a magnetic substance having the property of allowing magnetic flux to easily pass through in the air. That is, first permanent magnet 35a and second permanent magnet 35b magnetically couple first outside yoke 14a, second outside yoke 14b, first inside yoke 16a, and second inside yoke 16b.

As a result, first permanent magnet 35a and second permanent magnet 35b produce a magnetic field component in a direction along the extending direction of movable contact 10 between first fixed contact point 8a and first movable contact point 9a and between second fixed contact point 8b and second movable contact point 9b.

In the present embodiment, as shown in FIG. 18, since the outer width of first inside yoke 36a is larger than outer width of first outside yoke 34a, magnetic flux 20 is distributed so as to expand in the above-noted width direction in the vicinity of first inside yoke 36a and to converge in the vicinity of first outside yoke 34a. Similarly, since the outer width of second inside yoke 36b is larger than the outer width of second outside yoke 34b, magnetic flux 20 is distributed so as to expand in the above-noted width direction in the vicinity of second inside yoke 36b and to converge in the vicinity of second outside yoke 34b.

FIG. 20 is a partial enlarged view schematically showing a drive force acting on an arc produced when forward current flows, as viewed from the front side of the switch according to the third embodiment of the present invention with the arc cover removed.

As shown in FIG. 20, when forward current flows, according to Fleming's rule, drive force a1 acts on the arc produced between first fixed contact point 8a and first movable contact point 9a, and drive force a2 acts on the arc produced between second fixed contact point 8b and second movable contact point 9b.

For the arc produced between first fixed contact point 8a and first movable contact point 9a, drive force a1 mainly acts on one side in the above-noted width direction and thereafter mainly acts in a direction away from movable contact 10 in the extending direction of movable contact 10. As a result, the arc produced between first fixed contact point 8a and first movable contact point 9a is extended long under the action of drive force a1.

Similarly, for the arc produced between second fixed contact point 8b and second movable contact point 9b, drive force a2 mainly acts on the other side in the above-noted width direction and thereafter mainly acts in a direction away from movable contact 10 in the extending direction of movable contact 10. As a result, the arc produced between second fixed contact point 8b and second movable contact point 9b is extended long under the action of drive force a2.

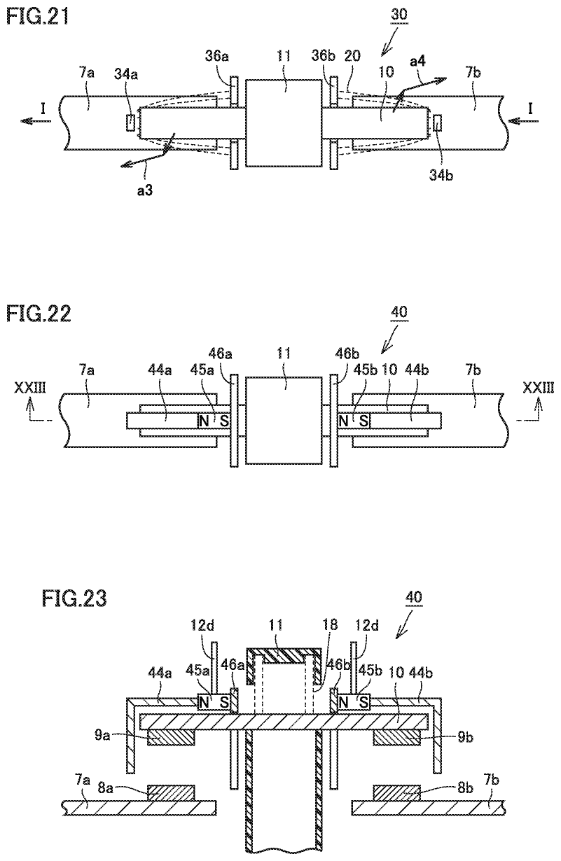

FIG. 21 is a partial enlarged view schematically showing a drive force acting on an arc produced when reverse current flows, as viewed from the front side of the switch according to the third embodiment of the present invention with the arc cover removed.

As shown in FIG. 21, when reverse current flows, according to Fleming's rule, drive force a3 acts on the arc produced between first fixed contact point 8a and first movable contact point 9a, and drive force a4 acts on the arc produced between second fixed contact point 8b and second movable contact point 9b.

For the arc produced between first fixed contact point 8a and first movable contact point 9a, drive force a3 mainly acts on the other side in the above-noted width direction and thereafter mainly acts in a direction away from movable contact 10 in the extending direction of movable contact 10. As a result, the arc produced between first fixed contact point 8a and first movable contact point 9a is extended long under the action of drive force a3.

Similarly, for the arc produced between second fixed contact point 8b and second movable contact point 9b, drive force a4 mainly acts on one side in the above-noted width direction and thereafter mainly acts in a direction away from movable contact 10 in the extending direction of movable contact 10. As a result, the arc produced between second fixed contact point 8b and second movable contact point 9b is extended long under the action of drive force a4.

As described above, in switch 30 according to the third embodiment of the present invention, both when forward current flows and when reverse current flows, the drive force can be exerted on the arc on either side in the above-noted width direction and thereafter exerted in a direction away from movable contact 10 in the extending direction of movable contact 10.

Also in switch 30 according to the third embodiment of the present invention, first permanent magnet 35a and second permanent magnet 35b magnetically couple first outside yoke 34a, second outside yoke 34b, first inside yoke 36a, and second inside yoke 36b, and produce a magnetic field component in a direction along the extending direction of movable contact 10 between first fixed contact point 8a and first movable contact point 9a and between second fixed contact point 8b and second movable contact point 9b. As a result, the drive force can be effectively exerted on the arc, and the arc-extinguishing performance of switch 30 can be enhanced.

Both when forward current flows and when reverse current flows, the drive force can be exerted on the arc on either side in the above-noted width direction and thereafter exerted in a direction away from movable contact 10 in the extending direction of movable contact 10. As a result, the arc-extinguishing performance of switch 30 can be more enhanced irrespective of the direction current flows.

In particular, in the above-noted width direction, the outer width of first inside yoke 36a is larger than the outer width of first outside yoke 34a, and the outer width of second inside yoke 36b is larger than the outer width of second outside yoke 34b, whereby the drive force can be exerted on either side in the above-noted width direction and thereafter effectively exerted in a direction away from movable contact 10 in the extending direction of movable contact 10, and therefore the arc can be extended longer. Thus, the arc-extinguishing performance of switch 30 can be further enhanced.

Since notch portion 36as is provided in first inside yoke 36a, converging of the magnetic flux produced between first outside yoke 34a and first inside yoke 36a near the center portion of first inside yoke 36a in the above-noted width direction can be reduced, and the magnetic flux distribution can be expanded in the above-noted width direction.

Similarly, since notch portion 36bs is provided in second inside yoke 36b, converging of the magnetic flux produced between second outside yoke 34b and second inside yoke 36b near the center portion of second inside yoke 36b in the above-noted width direction can be reduced, and the magnetic flux distribution can be expanded in the above-noted width direction.

Thus, the drive force can be exerted more effectively on the arc in a direction away from movable contact 10 in the extending direction of movable contact 10. As a result, the drive force can be effectively exerted on the arc, and the arc-extinguishing performance of the switch can be enhanced.

In the present embodiment, since first inside yoke 36a is connected to first permanent magnet 35a and second inside yoke 36b is connected to second permanent magnet 35b, the magnetic gap between the inside yoke and the permanent magnet is smaller and therefore a stronger drive force can be exerted on the arc. Thus, the arc-extinguishing performance of switch 30 can be enhanced. When the strength of drive force is kept, the size of the permanent magnet can be reduced, and the cost per permanent magnet can be reduced.

Each of first outside yoke 34a and first inside yoke 36a has an insulation coating, whereby short-circuiting between first fixed contact 7a and movable contact 10 can be suppressed. Each of second outside yoke 34b and second inside yoke 36b has an insulation coating, whereby short-circuiting between second fixed contact 7b and movable contact 10 can be suppressed.

### Fourth Embodiment

The switch according to a fourth embodiment of the present invention will be described below.

The switch according to the fourth embodiment of the present invention differs from switch 1 in the first embodiment mainly in the configuration of the permanent magnet, the first outside yoke, the second outside yoke, the first inside yoke, and the second inside yoke, and a description of the configuration similar to that of switch 1 in the first embodiment is not repeated.

FIG. 22 is a partial enlarged view of the switch according to the fourth embodiment of the present invention with the arc cover removed as viewed from the front side. FIG. 23 is a cross-sectional view as viewed from the direction of arrows XXIII-XXIII in FIG. 22.

As shown in FIG. 22 and FIG. 23, switch 40 according to the fourth embodiment of the present invention includes a first fixed contact 7a, a second fixed contact 7b, a movable contact 10, a drive shaft 11, a first outside yoke 44a, a second outside yoke 44b, a first inside yoke 46a, a second inside yoke 46b, a first permanent magnet 45a, and a second permanent magnet 45b.

First permanent magnet 45a and second permanent magnet 45b are provided at a position on the opposite side to first fixed contact 7a and second fixed contact 7b in the axial direction of drive shaft 11 with respect to movable contact 10. In the present embodiment, switch 40 includes two permanent magnets in each arc-extinguishing chamber.

A support 12d is attached to each of first permanent magnet 45a and second permanent magnet 45b. Each of first permanent magnet 45a and second permanent magnet 45b is fixed to the arc cover by support 12d.

First outside yoke 44a is formed of a magnetic substance such as iron, for example. One end of first outside yoke 44a is connected to the north pole of first permanent magnet 45a. The other end of first outside yoke 44a is located in the vicinity of first fixed contact point 8a and first movable contact point 9a.

In the present embodiment, first outside yoke 44a has a portion extending in a direction along the extending direction of movable contact 10 and a portion extending in a direction along the axial direction of drive shaft 11. The portion extending in a direction along the extending direction of movable contact 10 in first outside yoke 44a faces one main surface of movable contact 10 with a spacing therefrom. The portion extending in a direction along the axial direction of drive shaft 11 in first outside yoke 44a faces one end surface of movable contact 10 with a spacing therefrom.

The shape of first outside yoke 44a is not limited to the shape described above as long as a part of first outside yoke 44a is located at a position outside one end portion of movable contact 10 in a direction along the extending direction of movable contact 10 as viewed from the axial direction of drive shaft 11, within a range in which a magnetic field component described later can be produced.

Second outside yoke 44b is formed of a magnetic substance such as iron, for example. One end of second outside yoke 44b is connected to the south pole of second permanent magnet 45b. The other end of second outside yoke 44b is located in the vicinity of second fixed contact point 8b and second movable contact point 9b.

In the present embodiment, second outside yoke 44b has a portion extending in a direction along the extending direction of movable contact 10 and a portion extending in a direction along the axial direction of drive shaft 11. The portion extending in a direction along the extending direction of movable contact 10 in second outside yoke 34b faces one main surface of movable contact 10 with a spacing therefrom. The portion extending in a direction along the axial direction of drive shaft 11 in second outside yoke 44b faces the other end surface of movable contact 10 with a spacing therefrom.

The shape of second outside yoke 44b is not limited to the shape described above as long as a part of second outside yoke 44b is located at a position outside the other end portion of movable contact 10 in a direction along the extending direction of movable contact 10 as viewed from the axial direction of drive shaft 11, within a range in which a magnetic field component described later can be produced.

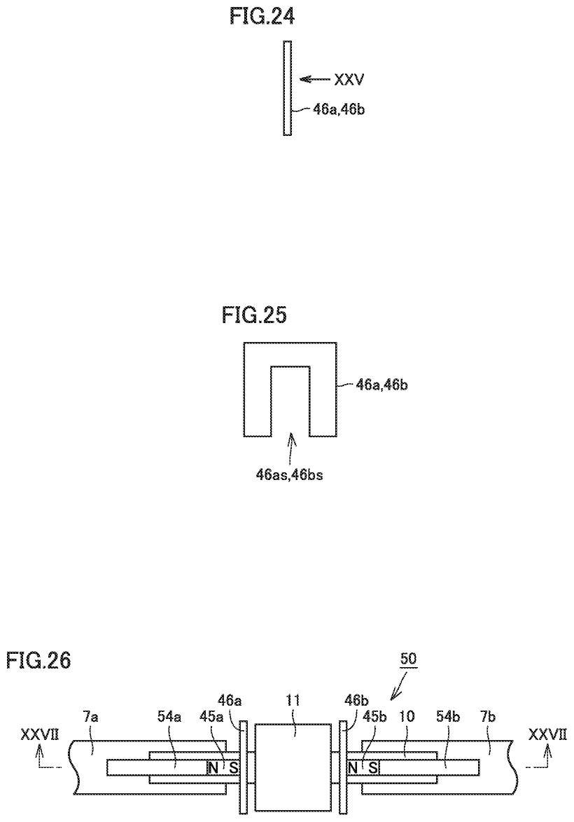

FIG. 24 is a view of the appearance of a member forming the inside yoke of the switch according to the fourth embodiment of the present invention as viewed from the side. FIG. 25 is a view of the member forming the inside yoke in FIG. 24 as viewed from the direction of arrow XXV.

As shown in FIG. 24 and FIG. 25, in the present embodiment, first inside yoke 46a and second inside yoke 46b are configured as separate parts. Each of first inside yoke 46a and second inside yoke 46b is formed of a sheet of magnetic substance such as iron. Each of first inside yoke 46a and second inside yoke 46b has a rectangular outer shape.

First inside yoke 46a has a notch portion 46as extending in the above-noted axial direction at a center portion in the above-noted width direction. Second inside yoke 46b has a notch portion 46bs extending in the above-noted axial direction at a center portion in the above-noted width direction. Notch portion 46as and notch portion 46bs have approximately the same shape and are open on the movable contact 10 side. The width of each of notch portion 46as and notch portion 46bs is larger than the width of movable contact 10. This can prevent each of first inside yoke 46a and second inside yoke 46b from interfering with movable contact 10.

One end portion of first inside yoke 46a is connected to the south pole of first permanent magnet 45a. One end portion of second inside yoke 46b is connected to the north pole of second permanent magnet 45b. The orientation of magnetic poles of each of first permanent magnet 45a and second permanent magnet 45b may be reversed. For example, one end portion of first inside yoke 46a may be connected to the north pole of first permanent magnet 45a, and one end portion of second inside yoke 46b may be connected to the south pole of second permanent magnet 45b. If the orientation of magnetic poles is changed, the arc driving direction described later is changed but the arc driving ability and the resulting interruption performance are equivalent.

First inside yoke 46a is located at a position between first fixed contact 7a and drive shaft 11 as viewed from the axial direction of drive shaft 11. Second inside yoke 46b is located at a position between second fixed contact 7b and drive shaft 11 as viewed from the axial direction of drive shaft 11.

In the present embodiment, a part of first outside yoke 44a and a part of first inside yoke 46a face each other between first fixed contact point 8a and first movable contact point 9a, as viewed from a direction along the extending direction of movable contact 10. The outer width of first inside yoke 46a is larger than the outer width of first outside yoke 44a in the above-noted width direction.

Although first outside yoke 44a and first inside yoke 46a do not necessarily face each other, it is preferable that a part of first outside yoke 44a and a part of first inside yoke 46a are located between first fixed contact point 8a and first movable contact point 9a as viewed from a direction along the extending direction of movable contact 10, in terms of producing a magnetic field component described later. The outer width of first inside yoke 46a may be equivalent to the outer width of first outside yoke 44a.

In the present embodiment, a part of second outside yoke 44b and a part of second inside yoke 46b face each other between second fixed contact point 8b and second movable contact point 9b, as viewed from a direction along the extending direction of movable contact 10. The outer width of second inside yoke 46b is larger than the outer width of second outside yoke 44b in the above-noted width direction.

Although second outside yoke 44b and second inside yoke 46b do not necessarily face each other, it is preferable that a part of second outside yoke 44b and a part of second inside yoke 46b are located between second fixed contact point 8b and second movable contact point 9b as viewed from a direction along the extending direction of movable contact 10, in terms of producing a magnetic field component described later. The outer width of second inside yoke 46b may be equivalent to the outer width of second outside yoke 44b.

First permanent magnet 45a and second permanent magnet 45b magnetically couple first outside yoke 44a, second outside yoke 44b, first inside yoke 46a, and second inside yoke 46b. As a result, first permanent magnet 45a and second permanent magnet 45b produce a magnetic field component in a direction along the extending direction of movable contact 10 between first fixed contact point 8a and first movable contact point 9a and between second fixed contact point 8b and second movable contact point 9b.

Also in switch 40 according to the fourth embodiment of the present invention, first permanent magnet 45a and second permanent magnet 45b magnetically couple first outside yoke 44a, second outside yoke 44b, first inside yoke 46a, and second inside yoke 46b, and produce a magnetic field component in a direction along the extending direction of movable contact 10 between first fixed contact point 8a and first movable contact point 9a and between second fixed contact point 8b and second movable contact point 9b. As a result, the drive force can be effectively exerted on the arc, and the arc-extinguishing performance of switch 40 can be enhanced.

Both when forward current flows and when reverse current flows, the drive force can be exerted on the arc on either side in the above-noted width direction and thereafter exerted in a direction away from movable contact 10 in the extending direction of movable contact 10. As a result, the arc-extinguishing performance of switch 30 can be more enhanced irrespective of the direction current flows.

In particular, in the above-noted width direction, the outer width of first inside yoke 46a is larger than the outer width of first outside yoke 44a, and the outer width of second inside yoke 46b is larger than the outer width of second outside yoke 44b, whereby the drive force can be exerted on either side in the above-noted width direction and thereafter effectively exerted in a direction away from movable contact 10 in the extending direction of movable contact 10, and therefore the arc can be extended longer. Thus, the arc-extinguishing performance of switch 40 can be further enhanced.

Since notch portion 46as is provided in first inside yoke 46a, converging of the magnetic flux produced between first outside yoke 44a and first inside yoke 46a near the center portion of first inside yoke 46a in the above-noted width direction can be reduced, and the magnetic flux distribution can be expanded in the above-noted width direction.

Similarly, since notch portion 46bs is provided in second inside yoke 46b, converging of the magnetic flux produced between second outside yoke 44b and second inside yoke 46b near the center portion of second inside yoke 46b in the above-noted width direction can be reduced, and the magnetic flux distribution can be expanded in the above-noted width direction.

Thus, the drive force can be exerted more effectively on the arc in a direction away from movable contact 10 in the extending direction of movable contact 10. As a result, the drive force can be effectively exerted on the arc, and the arc-extinguishing performance of the switch can be enhanced.

In the present embodiment, since first inside yoke 46a is connected to first permanent magnet 45a and second inside yoke 46b is connected to second permanent magnet 45b, the magnetic gap between the inside yoke and the permanent magnet is smaller and therefore a stronger drive force can be exerted on the arc. Thus, the arc-extinguishing performance of switch 40 can be enhanced. When the strength of drive force is kept, the size of the permanent magnet can be reduced and the cost per permanent magnet can be reduced.

### Fifth Embodiment

The switch according to a fifth embodiment of the present invention will be described below.

The switch according to the fifth embodiment of the present invention differs from switch 40 in the fourth embodiment in the shape of each of the first outside yoke and the second outside yoke, and a description of the configuration similar to that of switch 40 in the fourth embodiment is not repeated.

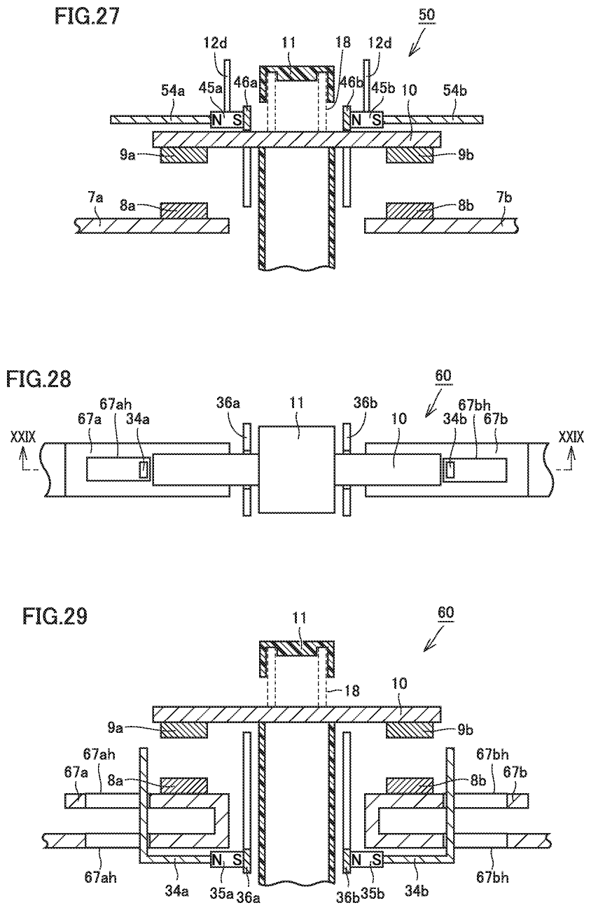

FIG. 26 is a partial enlarged view of the switch according to the fifth embodiment of the present invention with the arc cover removed as viewed from the front side. FIG. 27 is a cross-sectional view as viewed from the direction of arrows XXVII-XXVII in FIG. 26.

As shown in FIG. 26 and FIG. 27, switch 50 according to the fifth embodiment of the present invention includes a first fixed contact 7a, a second fixed contact 7b, a movable contact 10, a drive shaft 11, a first outside yoke 54a, a second outside yoke 54b, a first inside yoke 46a, a second inside yoke 46b, a first permanent magnet 45a, and a second permanent magnet 45b.

First outside yoke 54a is formed of a magnetic substance such as iron, for example. First outside yoke 54a extends in a direction along the extending direction of movable contact 10. First outside yoke 54a faces one main surface of movable contact 10 with a spacing therefrom. One end of first outside yoke 54a is connected to the north pole of first permanent magnet 45a. The orientation of magnetic poles may be reversed. The other end of first outside yoke 54a is located at a position outside one end portion of movable contact 10 in a direction along the extending direction of movable contact 10, as viewed from the axial direction of drive shaft 11.

Second outside yoke 54b is formed of a magnetic substance such as iron, for example. Second outside yoke 54b extends in a direction along the extending direction of movable contact 10. Second outside yoke 54b faces one main surface of movable contact 10 with a spacing therefrom. One end of second outside yoke 54b is connected to the south pole of second permanent magnet 45b. The orientation of magnetic poles may be reversed. The other end of second outside yoke 54b is located at a position outside the other end portion of movable contact 10 in a direction along the extending direction of movable contact 10, as viewed from the axial direction of drive shaft 11.

First permanent magnet 45a and second permanent magnet 45b magnetically couple first outside yoke 54a, second outside yoke 54b, first inside yoke 46a, and second inside yoke 46b. As a result, first permanent magnet 45a and second permanent magnet 45b produce a magnetic field component in a direction along the extending direction of movable contact 10 between first fixed contact point 8a and first movable contact point 9a and between second fixed contact point 8b and second movable contact point 9b.

Also in switch 50 according to the fifth embodiment of the present invention, first permanent magnet 45a and second permanent magnet 45b magnetically couple first outside yoke 54a, second outside yoke 54b, first inside yoke 46a, and second inside yoke 46b, and produce a magnetic field component in a direction along the extending direction of movable contact 10 between first fixed contact point 8a and first movable contact point 9a and between second fixed contact point 8b and second movable contact point 9b. As a result, the drive force can be effectively exerted on the arc, and the arc-extinguishing performance of switch 50 can be enhanced.

In the present embodiment, each of first outside yoke 54a and second outside yoke 54b can be formed in a simple shape. In addition, damage of first outside yoke 54a and second outside yoke 54b due to coming into contact with the arc can be suppressed.

### Sixth Embodiment

The switch according to a sixth embodiment of the present invention will be described below.

The switch according to the sixth embodiment of the present invention differs from switch 30 in the third embodiment in the shape of each of the first fixed contact and the second fixed contact, and a description of the configuration similar to that of switch 30 in the third embodiment is not repeated.

FIG. 28 is a partial enlarged view of the switch according to the sixth embodiment of the present invention with the arc cover removed as viewed from the front side. FIG. 29 is a cross-sectional view as viewed from the direction of arrows XXIX-XXIX in FIG. 28.

As shown in FIG. 28 and FIG. 29, switch 60 according to the sixth embodiment of the present invention includes a first fixed contact 67a, a second fixed contact 67b, a movable contact 10, a drive shaft 11, a first outside yoke 34a, a second outside yoke 34b, a first inside yoke 36a, a second inside yoke 36b, a first permanent magnet 35a, and a second permanent magnet 35b.

First fixed contact 67a has a longitudinal direction and includes a portion extending in the longitudinal direction so as to approach drive shaft 11, a portion bending from this portion and extending along drive shaft 11 so as to approach movable contact 10, and a portion bending from this portion and extending in the longitudinal direction so as to depart from drive shaft 11. In each of the portion extending in the longitudinal direction so as to approach drive shaft 11 and the portion extending along drive shaft 11 so as to approach movable contact 10, a slot-shaped through hole 67ah extending in the longitudinal direction is provided at a center portion in the above-noted width direction to allow first outside yoke 34a to pass through.

Second fixed contact 67b is disposed to be aligned in a row with first fixed contact 67a with a spacing therefrom. Second fixed contact 67b has a longitudinal direction and includes a portion extending in the longitudinal direction so as to approach drive shaft 11, a portion bending from this portion and extending along drive shaft 11 so as to approach movable contact 10, and a portion bending from this portion and extending in the longitudinal direction so as to depart from drive shaft 11. In each of the portion extending in the longitudinal direction so as to approach drive shaft 11 and the portion extending along drive shaft 11 so as to approach movable contact 10, a slot-shaped through hole 67bh extending in the longitudinal direction is provided at a center portion in the above-noted width direction to allow second outside yoke 34b to pass through.

First fixed contact point 8a is provided on a main surface of the other end portion in the longitudinal direction of the portion of first fixed contact 67a that extends in the longitudinal direction so as to depart from drive shaft 11. Second fixed contact point 8b is provided on a main surface of one end portion in the longitudinal direction of the portion of second fixed contact 67b that extends in the longitudinal direction so as to depart from drive shaft 11. First fixed contact point 8a and second fixed contact point 8b are aligned in the longitudinal direction of each of first fixed contact 67a and second fixed contact 67b.

In the present embodiment, since each of first fixed contact 67a and second fixed contact 67b has a bent shape, the self-magnetic field by current flowing through each of first fixed contact 67a and second fixed contact 67b is intensified, thereby enhancing the drive force acting on the arc.

In the present embodiment, through hole 67ah is provided in first fixed contact 67a, and through hole 67bh is provided in second fixed contact 67b. Thus, the density of current flowing through each of first fixed contact 67a and second fixed contact 67b is increased. This can intensify the electromagnetic force acting on the arc running on first fixed contact 67a or on second fixed contact 67b to improve the arc-interruption performance. Since through hole 67ah is provided in first fixed contact 67a and through hole 67bh is provided in second fixed contact 67b, damage of each of first outside yoke 34a and second outside yoke 34b due to coming into contact with the arc can be suppressed.

### Seventh Embodiment

The switch according to a seventh embodiment of the present invention will be described below.

The switch according to the seventh embodiment of the present invention differs from switch 60 in the sixth embodiment in that a depression is provided in the movable contact, and a description of the configuration similar to that of switch 60 in the sixth embodiment is not repeated.

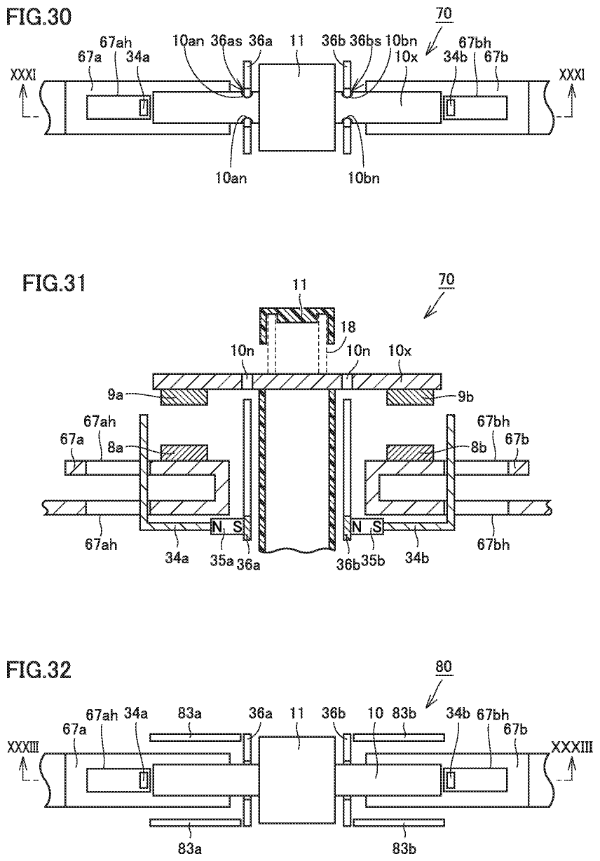

FIG. 30 is a partial enlarged view of the switch according to the seventh embodiment of the present invention with the arc cover removed as viewed from the front side. FIG. 31 is a cross-sectional view as viewed from the direction of arrows XXXI-XXXI in FIG. 30.

As shown in FIG. 30 and FIG. 31, switch 70 according to the seventh embodiment of the present invention includes a first fixed contact 67a, a second fixed contact 67b, a movable contact 10x, a drive shaft 11, a first outside yoke 34a, a second outside yoke 34b, a first inside yoke 36a, a second inside yoke 36b, a first permanent magnet 35a, and a second permanent magnet 35b.

Movable contact 10x has a depression 10an extending in the axial direction of drive shaft 11 at a position corresponding to notch portion 36as of first inside yoke 36a and a depression 10bn extending in the axial direction of drive shaft 11 at a position corresponding to notch portion 36bs of second inside yoke 36b, on both side surfaces vertical to the above-noted width direction.

In a switch, the movable contact may be displaced, for example, due to vibration. In the present embodiment, since depression 10an and depression 10bn are provided in movable contact 10x, the distance between each of first inside yoke 36a and second inside yoke 36b and movable contact 10x can be increased while the shape of each of first inside yoke 36a and second inside yoke 36b is kept. Thus, even when movable contact 10x is displaced, interference or contact of each of first inside yoke 36a and second inside yoke 36b with movable contact 10x can be suppressed while the drive force acting on the arc is kept.

### Eighth Embodiment

The switch according to an eighth embodiment of the present invention will be described below.

The switch according to the eighth embodiment of the present invention differs from switch 60 in the sixth embodiment in that an arc-extinguishing material is provided in the vicinity of the movable contact point and the fixed contact point, and a description of the configuration similar to that of switch 60 in the sixth embodiment is not repeated.

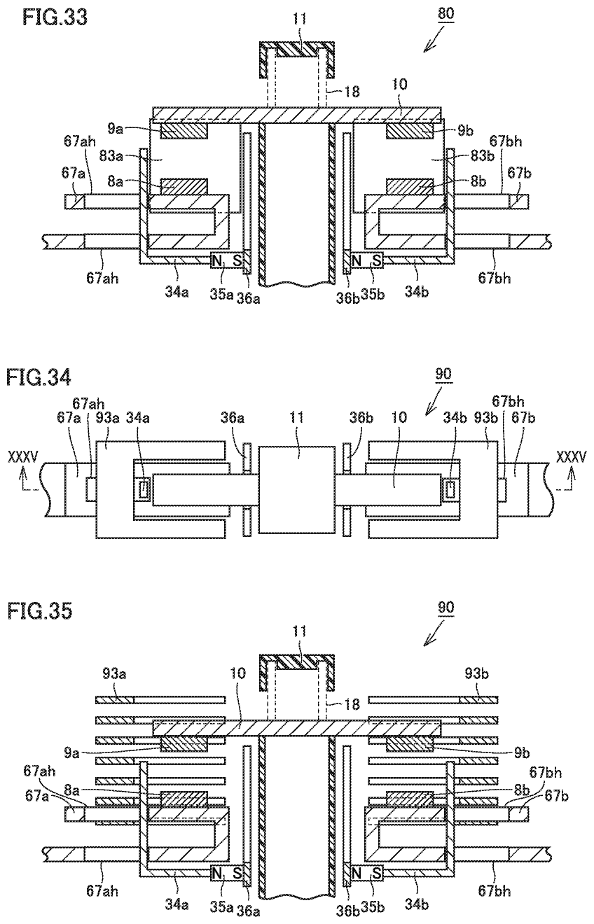

FIG. 32 is a partial enlarged view of the switch according to the eighth of the present invention with the arc cover removed as viewed from the front side. FIG. 33 is a cross-sectional view as viewed from the direction of arrows XXXIII-XXXIII in FIG. 32.

As shown in FIG. 32 and FIG. 33, switch 80 according to the eighth embodiment of the present invention includes a first fixed contact 67a, a second fixed contact 67b, a movable contact 10, a drive shaft 11, a first outside yoke 34a, a second outside yoke 34b, a first inside yoke 36a, a second inside yoke 36b, a first permanent magnet 35a, a second permanent magnet 35b, a first arc-extinguishing material 83a, and a second arc-extinguishing material 83b.

A pair of first arc-extinguishing materials 83a each have a flat plate-shaped outer shape and are disposed to face each other with a spacing therebetween in the above-noted width direction. First fixed contact point 8a and first movable contact point 9a are located between a pair of first arc-extinguishing materials 83a. First arc-extinguishing materials 83a are formed of an organic or inorganic insulating material or a metal material.

A pair of second arc-extinguishing materials 83b each have a flat plate-shaped outer shape and are disposed to face each other with a spacing therebetween in the above-noted width direction. Second fixed contact point 8b and second movable contact point 9b are located between a pair of second arc-extinguishing materials 83b. Second arc-extinguishing materials 83b are formed of an organic or inorganic insulating material or a metal material.

As shown in FIG. 20 and FIG. 21, each of the arc produced between first fixed contact point 8a and first movable contact point 9a and the arc produced between second fixed contact point 8b and second movable contact point 9b is driven in the above-noted width direction and thereafter driven in a direction away from movable contact 10 in the extending direction of movable contact 10.

In the present embodiment, since first arc-extinguishing materials 83a and second arc-extinguishing materials 83b are provided, the arc driven in the above-noted width direction comes into contact with first arc-extinguishing materials 83a or second arc-extinguishing materials 83b, whereby the arc can be attenuated in the initial state of opening of switch 80, the arc current can be limited, and the interruption reliability of switch 80 can be enhanced.

### Ninth Embodiment

The switch according to a ninth embodiment of the present invention will be described below.

The switch according to the ninth embodiment of the present invention differs from switch 60 in the sixth embodiment in that a grid is provided in the vicinity of the movable contact point and the fixed contact point, and a description of the configuration similar to that of switch 60 in the sixth embodiment is not repeated.

FIG. 34 is a partial enlarged view of the switch according to the ninth embodiment of the present invention with the arc cover removed as viewed from the front side. FIG. 35 is a cross-sectional view as viewed from the direction of arrows XXXV-XXXV in FIG. 34.

As shown in FIG. 34 and FIG. 35, switch 90 according to the ninth embodiment of the present invention includes a first fixed contact 67a, a second fixed contact 67b, a movable contact 10, a drive shaft 11, a first outside yoke 34a, a second outside yoke 34b, a first inside yoke 36a, a second inside yoke 36b, a first permanent magnet 35a, a second permanent magnet 35b, a first grid 93a, and a second grid 93b.

First grid 93a has a U-shaped outer shape as viewed from the axial direction of drive shaft 11. First grid 93a is disposed in the vicinity of first fixed contact point 8a and first movable contact point 9a. First grid 93a is disposed such that first fixed contact point 8a and first movable contact point 9a are located inside first grid 93a, as viewed from the axial direction of drive shaft 11. In the present embodiment, a plurality of first grids 93a are disposed to face each other with a spacing therebetween in the axial direction of drive shaft 11. However, one first grid 93a may be provided rather than two or more. First grid 93a is formed of a non-magnetic metal such as stainless steel or copper or a non-magnetic ceramic, or the like.

Second grid 93b has a U-shaped outer shape as viewed from the axial direction of drive shaft 11. Second grid 93b is disposed in the vicinity of second fixed contact point 8b and second movable contact point 9b. Second grid 93b is disposed such that second fixed contact point 8b and second movable contact point 9b are located inside second grid 93b, as viewed from the axial direction of drive shaft 11. In the present embodiment, a plurality of second grids 93b are disposed to face each other with a spacing therebetween in the axial direction of drive shaft 11. However, one second grid 93b may be provided rather than two or more. Second grid 93b is formed of a non-magnetic metal such as stainless steel or copper or a non-magnetic ceramic, or the like.

In the present embodiment, first outside yoke 34a is located inside first grid 93a, and second outside yoke 34b is located inside second grid 93b. However, first outside yoke 34a may be located outside first grid 93a, and second outside yoke 34b may be located outside second grid 93b.

In the present embodiment, since first grid 93a and second grid 93b are provided, after the arc is driven between first fixed contact point 8a and first movable contact point 9a and between second fixed contact point 8b and second movable contact point 9b, the arc is divided by first grid 93a and second grid 93b. Therefore, the arc voltage is increased, and the interruption performance of switch 90 can be enhanced. A plurality of first grids 93a and a plurality of second grids 93b are provided whereby the supported voltage of switch 90 can be increased.

### Tenth Embodiment

The switch according to a tenth embodiment of the present invention will be described below.

The switch according to the tenth embodiment of the present invention differs from the switch in the fourth embodiment mainly in the configuration of the permanent magnet, the first outside yoke, the second outside yoke, the first inside yoke, and the second inside yoke, and a description of the configuration similar to that of the switch in the fourth embodiment is not repeated.

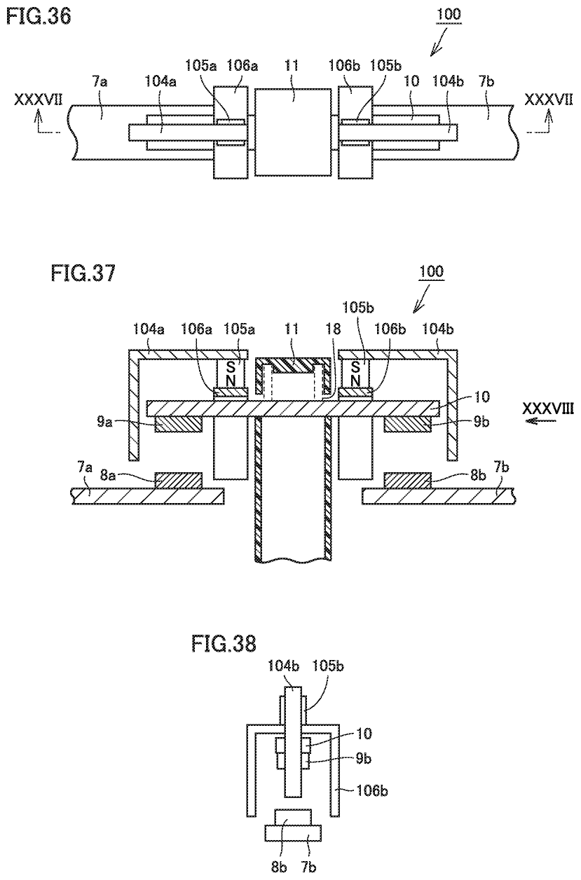

FIG. 36 is a partial enlarged view of the switch according to the tenth embodiment of the present invention with the arc cover removed as viewed from the front side. FIG. 37 is a cross-sectional view as viewed from the direction of arrows XXXVII-XXXVII in FIG. 36. FIG. 38 is a cross-sectional view as viewed from the direction XXXVIII in FIG. 37.

As shown in FIG. 36 to FIG. 38, switch 100 according to the tenth embodiment of the present invention includes a first fixed contact 7a, a second fixed contact 7b, a movable contact 10, a drive shaft 11, a first outside yoke 104a, a second outside yoke 104b, a first inside yoke 106a, a second inside yoke 106b, a first permanent magnet 105a, and a second permanent magnet 105b.

Each of first inside yoke 106a and second inside yoke 106b is formed by bending a sheet of magnetic substance. Each of first inside yoke 106a and second inside yoke 106b has an inverse U-shaped outer shape so as to cover a part of movable contact 10 from above. First inside yoke 106a and second inside yoke 106b may have an integrally shaped structure.

Although it is preferable that first inside yoke 106a is disposed between first movable contact point 9a and drive shaft 11, a part of first inside yoke 106a may cover first movable contact point 9a. Although it is preferable that second inside yoke 106b is disposed between second movable contact point 9b and drive shaft 11, a part of second inside yoke 106b may cover second movable contact point 9b.

The top portion of first inside yoke 106a is connected to the north pole of first permanent magnet 105a. The top portion of second inside yoke 106b is connected to the north pole of second permanent magnet 105b. The orientation of magnetic poles of each of first permanent magnet 105a and second permanent magnet 105b may be reversed. For example, the top portion of first inside yoke 106a may be connected to the south pole of first permanent magnet 105a, and the top portion of second inside yoke 106b may be connected to the south pole of second permanent magnet 105b.

First outside yoke 104a is disposed above first permanent magnet 105a, and one end of first outside yoke 104a is connected to the south pole of first permanent magnet 105a. The other end of first outside yoke 104a is located in the vicinity of first fixed contact point 8a and first movable contact point 9a.

Second outside yoke 104b is disposed above second permanent magnet 105b, and one end of second outside yoke 104b is connected to the south pole of second permanent magnet 105b. The other end of second outside yoke 104b is located in the vicinity of second fixed contact point 8b and second movable contact point 9b.

First permanent magnet 105a may be connected to the top portion of first outside yoke 104a, and first inside yoke 106a may be connected to the top portion of first permanent magnet 105a. Similarly, second permanent magnet 105b may be connected to the top portion of second outside yoke 104b, and second inside yoke 106b may be connected to the top portion of second permanent magnet 105b.

As shown in FIG. 38, the width of each of first inside yoke 106a and second inside yoke 106b is larger than the width of each of first outside yoke 104a and second outside yoke 104b, as viewed from a direction along the extending direction of movable contact 10. With this configuration, the drive force can be exerted on the arc on either side in the above-noted width direction and thereafter effectively exerted in a direction away from movable contact 10 in the extending direction of movable contact 10, and therefore the arc can be extended longer, in the same manner as switch 40 according to the fourth embodiment. Thus, the arc-extinguishing performance of switch 100 can be further enhanced.

In the present embodiment, since each of first inside yoke 106a and second inside yoke 106b can be easily shaped, each of first inside yoke 106a and second inside yoke 106b can be formed in a smaller size, and consequently, the size of each of first-phase arc-extinguishing chamber 2a and second-phase arc-extinguishing chamber 2b can be reduced.

In the foregoing embodiments, the configurations that can be combined with each other can be combined as appropriate.

The embodiments disclosed here should be understood as being illustrative in all respects and should not be construed as being limitative. Therefore, the technical scope of the present invention should not be interpreted only by the foregoing embodiments. All modifications that come within the meaning and range of equivalence to the claims are embraced here.

### REFERENCE SIGNS LIST

1, 30, 40, 50, 60, 70, 80, 90, 100 switch, 2a, 2b arc-extinguishing chamber, 3 operating coil, 4 fixed core, 5 movable core, 7a, 67a first fixed contact, 7b, 67b second fixed contact, 8a first fixed contact point, 8b second fixed contact point, 9a first movable contact point, 9b second movable contact point, 10, 10x movable contact, 10a main surface, 10an, 10bn depression, 10b one end surface, 10c the other end surface, 11 drive shaft, 11h hole portion, 12a mount, 12b base, 12c arc cover, 12d support, 13 grid, 14a, 34a, 44a, 54a, 104a first outside yoke, 14b, 34b, 44b, 54b, 104b second outside yoke, 15 permanent magnet, 16a, 26a, 36a, 46a, 106a first inside yoke, 16b, 26b, 36b, 46b, 106b second inside yoke, 17 insulating plate, 18 contact pressure spring, 20 magnetic flux, 26as, 26bs, 36as, 36bs, 46as, 46bs notch portion, 35a, 45a, 105a first permanent magnet, 35b, 45b, 105b second permanent magnet, 67ah, 67bh through hole, 83a first arc-extinguishing material, 83b second arc-extinguishing material, 93a first grid, 93b second grid, I current, a1, a2, a3, a4 drive force.

1. A switch comprising:
a first fixed contact having a first fixed contact point;
a second fixed contact disposed to be aligned in a row with a gap from the first fixed contact, the second fixed contact having a second fixed contact point;
a movable contact disposed to a side of the first fixed contact point and the second fixed contact point, the movable contact having a first movable contact point at one end portion at a position facing the first fixed contact point and a second movable contact point at another end portion at a position facing the second fixed contact point;
a drive shaft formed of an insulator and disposed to pass through the gap to move the movable contact to the side;
a first outside yoke formed of a magnetic substance, a part of the first outside yoke being located at a position outside the one end portion of the movable contact in a direction in which the first fixed contact point and the second fixed contact point are aligned;
a second outside yoke formed of a magnetic substance, a part of the second outside yoke being located at a position outside the other end portion of the movable contact in the direction aligned;
a first inside yoke formed of a magnetic substance, a part of the first inside yoke being located at a position between the first fixed contact and the drive shaft;
a second inside yoke formed of a magnetic substance, a part of the second inside yoke being located at a position between the second fixed contact and the drive shaft; and
a permanent magnet connected to each of the first outside yoke and the second outside yoke, wherein
the permanent magnet magnetically couples the first outside yoke, the second outside yoke, the first inside yoke, and the second inside yoke, and produces a magnetic field component in the direction aligned, between the first fixed contact point and the first movable contact point and between the second fixed contact point and the second movable contact point,
the movable contact extends in the direction aligned,
the first movable contact point is configured to come into contact with and separate from the first fixed contact point,
the second movable contact point is configured to come into contact with and separate from the second fixed contact point,
the drive shaft moves the movable contact in an axial direction vertical to the direction aligned while keeping the first fixed contact point and the first movable contact point facing each other and while keeping the second fixed contact point and the second movable contact point facing each other,
the permanent magnet is disposed at a position on an opposite side to the first fixed contact and the second fixed contact in the axial direction with respect to the movable contact or at a position on an opposite side to the movable contact in the axial direction with respect to the first fixed contact and the second fixed contact,
a part of the first outside yoke and a part of the first inside yoke face each other between the first fixed contact point and the first movable contact point, as viewed from the direction aligned, and
a part of the second outside yoke and a part of the second inside yoke face each other between the second fixed contact point and the second movable contact point, as viewed from the direction aligned.

2.-14. (canceled)

15. A switch comprising:
a first fixed contact having a first fixed contact point;
a second fixed contact disposed to be aligned in a row with a gap from the first fixed contact, the second fixed contact having a second fixed contact point;
a movable contact disposed to a side of the first fixed contact point and the second fixed contact point, the movable contact having a first movable contact point at one end portion at a position facing the first fixed contact point and a second movable contact point at another end portion at a position facing the second fixed contact point;
a drive shaft formed of an insulator and disposed to pass through the gap to move the movable contact to the side;
a first outside yoke formed of a magnetic substance, a part of the first outside yoke being located at a position outside the one end portion of the movable contact in a direction in which the first fixed contact point and the second fixed contact point are aligned;
a second outside yoke formed of a magnetic substance, a part of the second outside yoke being located at a position outside the other end portion of the movable contact in the direction aligned;
a first inside yoke formed of a magnetic substance, a part of the first inside yoke being located at a position between the first fixed contact and the drive shaft;
a second inside yoke formed of a magnetic substance, a part of the second inside yoke being located at a position between the second fixed contact and the drive shaft; and
a permanent magnet connected to each of the first outside yoke and the second outside yoke, wherein
the permanent magnet magnetically couples the first outside yoke, the second outside yoke, the first inside yoke, and the second inside yoke, and produces a magnetic field component in the direction aligned, between the first fixed contact point and the first movable contact point and between the second fixed contact point and the second movable contact point,
the movable contact extends in the direction aligned,
the first movable contact point is configured to come into contact with and separate from the first fixed contact point,
the second movable contact point is configured to come into contact with and separate from the second fixed contact point,
the drive shaft moves the movable contact in an axial direction vertical to the direction aligned while keeping the first fixed contact point and the first movable contact point facing each other and while keeping the second fixed contact point and the second movable contact point facing each other,
the permanent magnet is disposed at a position on an opposite side to the first fixed contact and the second fixed contact in the axial direction with respect to the movable contact or at a position on an opposite side to the movable contact in the axial direction with respect to the first fixed contact and the second fixed contact,
an outer width of the first inside yoke is larger than an outer width of the first outside yoke in a width direction vertical to each of the direction aligned and the axial direction, and
an outer width of the second inside yoke is larger than an outer width of the second outside yoke in the width direction.

16. A switch comprising:
a first fixed contact having a first fixed contact point;
a second fixed contact disposed to be aligned in a row with a gap from the first fixed contact, the second fixed contact having a second fixed contact point;
a movable contact disposed to a side of the first fixed contact point and the second fixed contact point, the movable contact having a first movable contact point at one end portion at a position facing the first fixed contact point and a second movable contact point at another end portion at a position facing the second fixed contact point;
a drive shaft formed of an insulator and disposed to pass through the gap to move the movable contact to the side;
a first outside yoke formed of a magnetic substance, a part of the first outside yoke being located at a position outside the one end portion of the movable contact in a direction in which the first fixed contact point and the second fixed contact point are aligned;
a second outside yoke formed of a magnetic substance, a part of the second outside yoke being located at a position outside the other end portion of the movable contact in the direction aligned;
a first inside yoke formed of a magnetic substance, a part of the first inside yoke being located at a position between the first fixed contact and the drive shaft;
a second inside yoke formed of a magnetic substance, a part of the second inside yoke being located at a position between the second fixed contact and the drive shaft; and
a permanent magnet connected to each of the first outside yoke and the second outside yoke, wherein
the permanent magnet magnetically couples the first outside yoke, the second outside yoke, the first inside yoke, and the second inside yoke, and produces a magnetic field component in the direction aligned, between the first fixed contact point and the first movable contact point and between the second fixed contact point and the second movable contact point,
the movable contact extends in the direction aligned,
the first movable contact point is configured to come into contact with and separate from the first fixed contact point,
the second movable contact point is configured to come into contact with and separate from the second fixed contact point,
the drive shaft moves the movable contact in an axial direction vertical to the direction aligned while keeping the first fixed contact point and the first movable contact point facing each other and while keeping the second fixed contact point and the second movable contact point facing each other,
the permanent magnet is disposed at a position on an opposite side to the first fixed contact and the second fixed contact in the axial direction with respect to the movable contact or at a position on an opposite side to the movable contact in the axial direction with respect to the first fixed contact and the second fixed contact,
the first inside yoke has a notch portion extending in the axial direction at a center portion in a width direction vertical to each of the direction aligned and the axial direction, and
the second inside yoke has a notch portion extending in the axial direction at a center portion in the width direction.

17. The switch according to claim 1, wherein
a part of the first outside yoke and a part of the first inside yoke are located between the first fixed contact point and the first movable contact point, as viewed from the direction aligned, and
a part of the second outside yoke and a part of the second inside yoke are located between the second fixed contact point and the second movable contact point, as viewed from the direction aligned.

18. The switch according to claim 1, wherein the switch comprises only one permanent magnet as the permanent magnet.

19. The switch according to claim 1, wherein the first inside yoke and the second inside yoke are integrally formed.

20. The switch according to claim 1, wherein each of the first inside yoke and the second inside yoke is connected to the drive shaft.

21. The switch according to claim 1, wherein each of the first inside yoke and the second inside yoke is connected to the permanent magnet.

22. The switch according to claim 1, wherein
the first outside yoke passes through a center portion of the first fixed contact in a width direction vertical to each of the direction aligned and an axial direction vertical to the direction aligned, and
the second outside yoke passes through a center portion of the second fixed contact in the width direction.

23. The switch according to claim 1, wherein at least one of the first outside yoke, the second outside yoke, the first inside yoke, and the second inside yoke has an insulation coating.

24. The switch according to claim 22, wherein
a slot-shaped through hole extending in the direction aligned is disposed at the center portion of the first fixed contact to allow the first outside yoke to pass through, and
a slot-shaped through hole extending in the direction aligned is disposed at the center portion of the second fixed contact to allow the second outside yoke to pass through.

25. The switch according to claim 16, wherein the movable contact has a depression extending in the axial direction, at a position corresponding to the notch portion of each of the first inside yoke and the second inside yoke on both side surfaces vertical to a width direction vertical to each of the direction aligned and the axial direction.
